(19) United States
(12) Patent Application Publication
(10) Pub. No.: US 2026/0290291 A1
(43) Pub. Date: Sep. 24, 2026

(54) SYSTEM

(71) Applicant: SoftBank Group Corp., Tokyo (JP)

(72) Inventor: Masahiro OKUI, Tokyo (JP)

(73) Assignee: SoftBank Group Corp., Tokyo (JP)

(21) Appl. No.: 19/567,056

(22) Filed: Mar. 14, 2026

(30) Foreign Application Priority Data
Mar. 19, 2025 (JP) 2025-045135

(51) Int. Cl. G10H 1/00; G06F 40/30; G10G 1/00; G10H 1/38; G10H 1/40; G10L 13/033; G10L 13/08; G10L 15/26; G10L 25/18; G10L 25/90

(52) U.S. Cl. CPC G10H 1/0025; G06F 40/30; G10G 1/00; G10H 1/0041; G10H 1/38; G10H 1/40; G10L 13/0335; G10L 13/08; G10L 15/26; G10L 25/18; G10L 25/90; G10H 2210/005; G10H 2210/056; G10H 2210/066; G10H 2210/071; G10H 2210/081; G10H 2210/111; G10H 2210/576; G10H 2240/131; G10H 2250/311; G10L 2025/906

(57) ABSTRACT

A system includes a processor that is configured to receive, as inputs, a user voice, text data, a humming melody, and a type of music, analyze the text data using natural language processing techniques and generate formatted text data, analyze music data based on music theory and generate an arranged piece of music, and generate a prompt sentence by using a generative AI model, perform sentiment analysis based on the generated prompt sentence, and reflect a result of the sentiment analysis in generation of the arranged piece of music.

### CROSS-REFERENCE TO RELATED APPLICATION

This application is based on and claims priority under 35 USC 119 from Japanese Patent Application No. 2025-045135 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional music creation systems require users to possess specialized musical knowledge or advanced production skills in order to generate high-quality musical works. In particular, users who can provide only simple inputs, such as natural language lyrics, humming melodies, or casual voice recordings, face difficulty in transforming these inputs into musically arranged pieces that reflect nuanced emotional content. Existing systems typically lack integrated processing that combines natural language processing, music theory-based arrangement, and emotion-aware generative AI, and therefore fail to provide music that accurately reflects the emotional intent expressed in the user's text or voice. Furthermore, even when music is generated, there are problems in that the distribution of the generated music must be performed manually on separate digital distribution platforms, and that the generated music data is often provided in formats that are not suitable for further editing by users acting as music creators. Accordingly, there is a need for a system that, based on multimodal user inputs including voice, text, humming melody, and music type, can automatically generate emotionally consistent and musically arranged content, can seamlessly prepare the content for digital distribution, and can provide the music data in an editable form suitable for user-driven music production.

### SUMMARY

In order to solve the above-described problems, an embodiment of the present invention provides a system comprising a processor, wherein the processor is configured to receive, as inputs, a user voice, text data, a humming melody, and a type of music, analyze the text data using natural language processing techniques, and generate formatted text data. The processor is further configured to analyze music data based on music theory, including at least melody, harmony, and rhythm derived from the humming melody and the specified type of music, and to generate an arranged piece of music that conforms to an appropriate musical structure. In addition, the processor is configured to use a generative AI model to generate a prompt sentence, perform sentiment analysis based on the generated prompt sentence, and reflect a result of the sentiment analysis in the generation of the arranged piece of music so that musical parameters such as tempo, key, chord progression, instrumentation, and dynamics are adjusted in accordance with an emotional state inferred from the user's text or voice. Furthermore, the processor is configured to upload the arranged piece of music to a digital distribution platform so that the arranged piece of music can be distributed in a digital format without requiring a separate manual distribution operation by the user. The processor is also configured to provide generated music data in an editable format, thereby enabling the user to perform music production as a music creator by modifying, rearranging, or further enriching the generated musical content.

The term “user voice” refers to an audio signal including spoken or sung sound produced by a user and captured through a microphone or equivalent audio input device for use as input to the system.

The term “text data” refers to character-based information including, for example, lyrics, descriptions, or other natural language sentences provided by a user or obtained from an external source.

The term “humming melody” refers to a sequence of pitched vocal sounds without full lyrics, produced by a user humming or vocalizing, from which melodic information such as pitch contour and rhythm can be extracted.

The term “type of music” refers to information indicating at least a musical style, genre, or category, such as pop, rock, jazz, or classical, and may further include sub-style specifications or mood indications used to guide music generation.

The term “natural language processing techniques” refers to computational methods for analyzing and processing human language text, including but not limited to tokenization, parsing, semantic analysis, grammar correction, and text formatting.

The term “formatted text data” refers to text data that has been processed and structured by the system, for example by correcting grammar and spelling, adjusting line breaks or sections, and arranging phrases for suitability in musical usage such as lyrics.

The term “music data” refers to information representing musical content, including at least pitch, rhythm, and optionally harmony, structure, and instrumentation, and may be stored in symbolic, audio, or mixed formats.

The term “arranged piece of music” refers to music data that has been processed according to music theory and stylistic parameters to define at least a melody, harmony, rhythm, instrumentation, and temporal structure suitable for playback or distribution.

The term “generative AI model” refers to an artificial intelligence model configured to generate data, such as text or prompts, from input conditions, and may include, for example, neural network-based language models.

The term “prompt sentence” refers to a text sequence generated by the generative AI model and used to condition or guide subsequent processing, including at least sentiment analysis and music generation.

The term “sentiment analysis” refers to a process of automatically determining emotional attributes, such as positivity, negativity, arousal, or specific emotions (for example, sadness, joy, anger), from text or related data.

The term “result of the sentiment analysis” refers to information output by the sentiment analysis process indicating one or more emotional states, scores, or categories that are used to control parameters of music generation.

The term “digital distribution platform” refers to a network-connected service or system capable of receiving digital audio files and making them available to end users through streaming, downloading, or other electronic delivery mechanisms.

The term “editable format” refers to a data format in which generated music data can be modified, rearranged, or extended by a user, and may include, for example, MIDI files, project files for digital audio workstations, or structured symbolic notation formats.

The term “music production as a music creator” refers to an activity in which a user undertakes creative editing, arranging, mixing, or composing operations on music data, using the generated music as a starting point or component of an original musical work.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

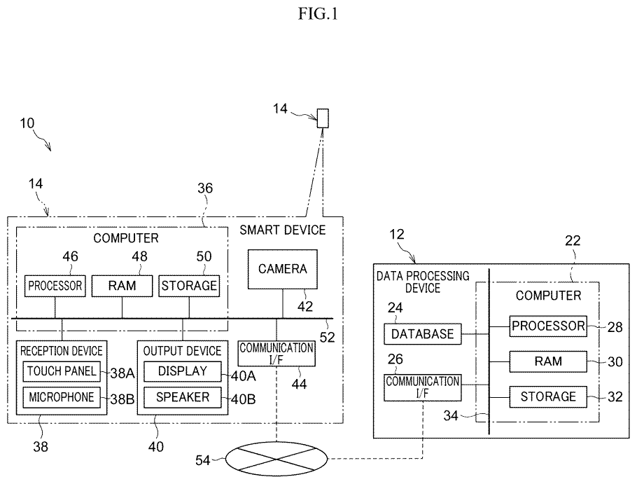

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

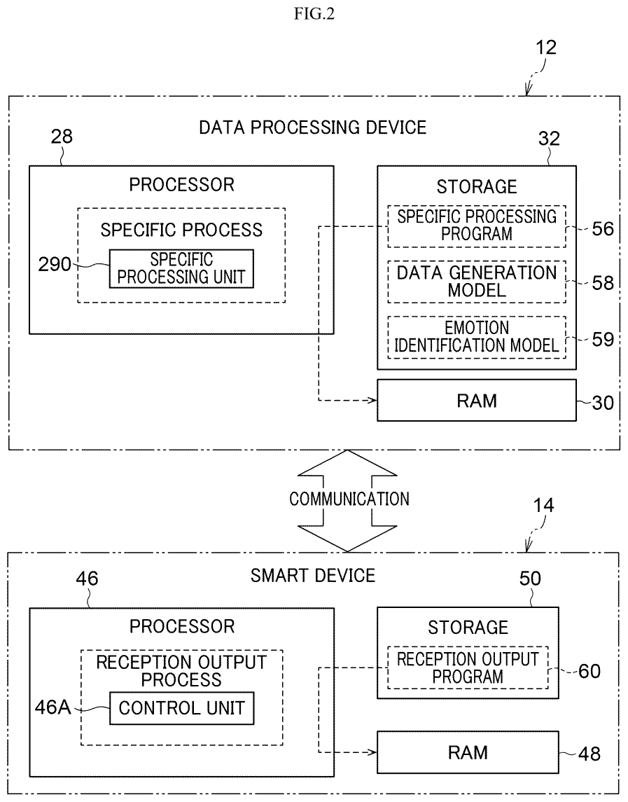

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented music creation environments impose several technical limitations on how user-provided voice data, lyric text data, and control parameters can be processed and combined to generate music content. In many existing systems, voice signals and humming melodies are merely recorded as raw audio streams and are not structurally integrated with text data or genre data in a way that can be effectively leveraged by a generative artificial intelligence model. As a result, the underlying computing devices often handle heterogeneous input modalities in a fragmented manner, leading to inefficient data flows, redundant processing, and restricted controllability of the music generation process.

Furthermore, typical music generation systems fail to maintain a consistent and machine-tractable history that links original input data, intermediate prompt sentences for generative models, model identification information, and final digital music files. This lack of structured record information degrades the ability of computer systems to manage versioning, reproduce past results, and perform traceable re-generation or editing. Consequently, when users attempt to iteratively refine songs, the computing environment has difficulty reconstructing prior conditions, which leads to repeated processing, inconsistent outputs, and increased computational load.

Another technical problem is that existing systems often treat the generative artificial intelligence model as a black box with minimal context control. The construction of prompts for the model is typically ad hoc and not based on an explicit, structured basic data representation that integrates recognized voice text, lyric text, and music type parameters. This results in suboptimal utilization of computational resources in the model-serving infrastructure and limits the precision with which a processor can steer model outputs toward a desired musical structure, emotion, or arrangement. In particular, the absence of a dedicated prompt-construction mechanism within the server side leads to lower reproducibility of generated results and less efficient use of network and storage resources due to unnecessary trial-and-error generation.

In addition, many systems provide only final audio files without exposing the underlying symbolic or structural music information in an editable format. This constrains downstream processing by external devices and applications, such as editors or digital audio workstations, and prevents them from efficiently modifying or regenerating music using structured data. From the perspective of computer technology, this leads to an architecture in which data representations are prematurely fixed at the audio waveform level, limiting system extensibility, interoperability, and the ability of distributed computing environments to share and reuse intermediate representations.

Accordingly, there is a need for a computer system that can: (i) systematically convert and integrate voice information and lyric text into unified basic data; (ii) construct structured prompt sentences for generative artificial intelligence models based on such basic data and music type information; (iii) obtain and manage music information as symbolic or waveform data; (iv) convert symbolic data into standardized digital music files; and (v) maintain explicit record information linking inputs, prompts, model identifiers, and generated outputs. Such a system should improve the internal data handling, traceability, and controllability of the entire music generation pipeline, thereby providing a concrete improvement to computer functionality rather than merely automating a human creative process.

The specific processing by the specific processing unit 290 of the data processing device 12 in Example 1 is realized by the following means.

The present invention provides a server comprising a processor and a memory storing instructions that, when executed by the processor, cause the server to receive, as inputs from a terminal device, user voice information, character information, melody information represented by voice, and music type information; convert, by using a speech recognition component, the user voice information and the melody information represented by voice into character information; generate basic data by integrating the converted character information with the character information; construct, on the basis of the basic data and the music type information, a prompt sentence in a natural language including emotion information and structure information; generate model input information including the prompt sentence configured as input to a generative artificial intelligence model; obtain, by transmitting the model input information to the generative artificial intelligence model, music information including musical structure information and performance information, and output the music information as symbolic information or waveform information; when the music information is the symbolic information, convert the symbolic information into an acoustic waveform by a synthesis process and encode the acoustic waveform as a digital music file in a standardized acoustic data format; store the digital music file in a storage device while associating the digital music file with identification information and attribute information to generate distribution information that enables an external terminal to access the digital music file; and accumulate, as record information, correspondence among the basic data, the prompt sentence, identification information of the generative artificial intelligence model, and the digital music file, and manage a generation history of music on the basis of the record information. This enables the computing system to internally standardize heterogeneous input modalities into unified basic data, to generate and apply structured prompt sentences for controlling a generative artificial intelligence model, to efficiently convert symbolic outputs into distributable digital music files, and to maintain traceable associations between inputs, prompts, model versions, and outputs, thereby improving data flow efficiency, reproducibility, and overall functionality of computer-based music generation.

The term “user voice information” refers to audio data representing a user's spoken or sung voice captured by an input device and provided to the server for processing.

The term “character information” refers to textual data expressed as a sequence of characters, including but not limited to lyrics, annotations, or other natural language strings input by a user or generated by the server.

The term “melody information represented by voice” refers to audio data in which a user expresses a melodic contour, rhythm, or pitch pattern by humming, singing, or otherwise vocalizing, without limitation to any particular language.

The term “music type information” refers to classification data indicating a category or style of music, such as a genre, mood, or arrangement type, used to control or constrain music generation.

The term “speech recognition technique” refers to a computational process that analyzes audio signals containing speech or vocal sounds and converts the audio signals into corresponding character information.

The term “basic data” refers to an internal data structure in which character information obtained by speech recognition is integrated with character information directly input by a user, optionally together with associated control parameters.

The term “prompt sentence” refers to a natural language expression constructed by the server that encodes instructions, constraints, and contextual information for a generative artificial intelligence model.

The term “generative artificial intelligence model” refers to a machine learning model configured to produce new data, such as music information, in response to input data including a prompt sentence, based on parameters learned from training data.

The term “model input information” refers to structured data, including at least a prompt sentence and optionally additional parameters, formatted for submission to a generative artificial intelligence model.

The term “music information” refers to data describing a musical work, including at least musical structure information and performance information, and expressed as either symbolic information or waveform information.

The term “musical structure information” refers to data describing high-level organization of a piece of music, including but not limited to sections, chord progressions, melodic lines, rhythm patterns, and temporal arrangements.

The term “performance information” refers to data specifying how musical structure is rendered as sound, including but not limited to instrument assignments, dynamics, articulation, timing, and expression parameters.

The term “symbolic information” refers to an abstract representation of music, such as notes, chords, durations, and control events, not limited to any particular file format and distinct from raw audio waveforms.

The term “waveform information” refers to numerical data representing a time-varying audio signal, including, for example, a sampled acoustic waveform of a generated piece of music.

The term “synthesis process” refers to a computational procedure that converts symbolic information into waveform information by simulating or generating audio signals corresponding to musical events.

The term “digital music file” refers to a data file containing encoded waveform information in a standardized digital audio format suitable for storage, transmission, and playback by electronic devices.

The term “standardized acoustic data format” refers to a predefined digital audio encoding specification, such as a pulse-code modulation format or compressed audio format, that is interpretable by general-purpose playback software and hardware.

The term “storage device” refers to a physical or virtual data storage resource, including but not limited to non-volatile memory, magnetic storage, optical storage, or network-attached storage, used to persistently store digital data.

The term “identification information” refers to data used to uniquely or distinctively identify an item of data or an entity, such as an identifier for a user, a song, a model instance, or a processing session.

The term “attribute information” refers to descriptive metadata associated with an item of data, such as title, genre, duration, creation time, or other properties relevant to management or retrieval.

The term “distribution information” refers to data enabling access to a digital music file by an external device, including, for example, a location reference, access control information, or a network resource identifier.

The term “external terminal” refers to a computing device, separate from the server, configured to communicate with the server over a network and to access or play digital music files.

The term “record information” refers to stored data that describes relationships among basic data, prompt sentences, generative artificial intelligence model identification information, and corresponding digital music files.

The term “generation history of music” refers to a collection of record information representing chronological or logical sequences of music generation operations, including their inputs, intermediate representations, and outputs.

The term “external apparatus” refers to any hardware device or computing system, including but not limited to a terminal, that is capable of communicating with the server to receive, edit, or reproduce music-related data.

The term “editable information format” refers to a representation of music information that allows modification of musical parameters, such as symbolic notation or structured descriptors, by an application executing on an external apparatus.

In one embodiment, the server, the terminal, and the user cooperate to implement the claimed system. The server is implemented as one or more computer devices including at least one processor and a memory. The server may be realized on a general-purpose computing platform such as a rack-mounted computer, a virtual machine in a cloud computing environment, or a specialized hardware appliance including a graphics processing unit. The terminal is implemented as a user-operated device such as a smartphone, a tablet computer, a personal computer, or a web browser running on such devices. The user is a human operator who provides inputs and consumes outputs of the system.

The terminal executes application software that presents a graphical user interface including at least a text input field, a recording control element, and a selection control element for music type information. The terminal uses hardware such as a built-in microphone, a touch-sensitive display, and a loudspeaker. The terminal software may be implemented as a native mobile application using a platform-specific software development kit, as a desktop application using a general-purpose framework, or as a web application rendered in a browser. The terminal uses an operating system audio application programming interface, such as an audio recording interface in a mobile operating system or a web audio interface in a browser, to capture acoustic signals of the user's voice and humming.

The terminal converts the captured acoustic signals into digitized audio data by sampling the input at a predetermined sampling rate and quantizing the signal into numerical values. The terminal may apply preprocessing such as normalization of amplitude, removal of leading and trailing silence, and noise reduction by applying digital signal processing algorithms. The terminal encodes the processed audio into a standardized audio container format, such as an uncompressed or lossless format, using a multimedia library or a native encoder of the operating system. The terminal then packages the encoded audio together with character information and music type information into a request data structure. The request data structure uses a hierarchical representation such as a key-value collection, and is serialized for communication to the server via a network using a communication protocol such as an HTTP-based protocol over a secure transport layer.

The server receives the request data through a network interface and a communication stack implemented by an operating system. The server executes server application software, for example based on a web application framework, that parses the received request data and separates it into the audio portion, the character information portion, and the music type information portion. The server then stores the audio portion into a storage device such as a non-volatile memory or a network-attached storage system, and registers associated metadata such as a request identifier, a user identifier, and a timestamp into a data management component such as a relational data management system.

The server converts the user voice information and the melody information represented by voice into character information by invoking a speech recognition module. The speech recognition module may be implemented as a local software library or as a remote recognition service accessed by network communication. In one example, the speech recognition module includes an acoustic model and a language model realized as a deep neural network such as a recurrent neural network or a transformer-based network. The acoustic model receives, as input, short-time spectral features derived from the digitized audio, such as Mel-frequency cepstral coefficients or log-mel spectrograms, and outputs probability distributions over phonetic units. The language model combines phonetic sequences into words or sub-word tokens by maximizing a likelihood under a statistical or neural sequence model. The server acquires from this module a transcription result that includes a sequence of characters representing recognized content, optionally with timing information and confidence scores.

The server transforms the raw transcription result into normalized character information by applying string processing operations, such as removal of filler tokens, correction of repeated symbols, and segmentation into logical phrases. The server then integrates the normalized character information derived from the recognition with the character information directly input by the user. To do so, the server uses an internal data structure referred to as basic data, which may be realized as a structured record including fields for user-supplied text, recognized text, music type information, and additional control parameters. The server stores this basic data in memory and in persistent storage.

The server constructs a prompt sentence in a natural language based on the basic data and the music type information. To construct the prompt sentence, the server uses a prompt construction module that takes the basic data as input and outputs a text string. The prompt construction module applies a deterministic template or a set of templates that insert specific elements of the basic data into predefined positions, and may augment the prompt with emotion information and structure information. For example, the server may analyze the character information to detect sentiment polarity and intensity, using a sentiment analysis model, and encode the result as emotion descriptors such as “sad,” “joyful,” or “energetic.” The server may also assign structure labels such as “verse,” “chorus,” or “bridge” based on the position of lines and user-defined markers. These descriptors are then inserted into the prompt sentence.

In one concrete example, the server generates a prompt sentence of the following form: “Lyrics: ‘Love Song’. Melody: Use the melodic contour and rhythm implied by the user's humming (transcribed from the provided audio). Genre: Pop. Based on these inputs, generate a full pop song with a verse-chorus structure, a catchy main hook, and an arrangement suitable for streaming platforms.”

The server generates model input information that includes at least this prompt sentence and, optionally, additional parameters such as a desired length of the generated piece, a tempo range, and a complexity level. The model input information is represented as a data structure including a text field for the prompt sentence and numeric fields for control parameters. The server then transmits this model input information to a generative AI model execution environment.

The server hosts or accesses a generative AI model configured to output music information.

In one embodiment, the generative AI model includes two modules: a textual-to-structure module and a structure-to-music module. The textual-to-structure module may be implemented as a transformer-based neural network trained to map the prompt sentence and embedded control parameters to a sequence of latent tokens representing musical sections, chords, and melodic motifs. The structure-to-music module may be implemented as a sequence generator that outputs symbolic musical events, such as note onset times, pitches, durations, and instrument identifiers. The model is stored in memory as sets of weight parameters for multiple layers, including embedding layers, attention layers, feed-forward layers, and normalization layers. The model has been trained in advance using supervised or self-supervised learning on a corpus of paired textual descriptions and symbolic music data.

The generative AI model receives the prompt sentence and associated parameters, converts them into internal representations using a tokenizer and an embedding function, and propagates them through the neural network layers. During inference, the model uses a decoding algorithm such as beam search, top-k sampling, or nucleus sampling to generate a sequence of output tokens representing music information. The server receives this sequence as symbolic information, which may correspond to a standardized form such as a note sequence, an event list, or a plano-roll representation. The server may also output waveform information directly if the generative AI model includes a neural vocoder or audio synthesizer module that maps symbolic sequences to acoustic waveforms.

The server processes the music information differently depending on whether it is symbolic or waveform information. When the music information is symbolic information, the server passes it to a synthesis process. The synthesis process uses a signal generation module, such as a software synthesizer, which implements instrument models, envelope generation, and mixing. The symbolic information is parsed into note events, each including attributes such as pitch, velocity, duration, and channel. The synthesizer converts each symbolic event into a corresponding audio segment by computing digital waveforms using methods such as wavetable synthesis, sample-based playback, or subtractive synthesis. The server mixes and sums the audio segments according to temporal alignment to generate an acoustic waveform representing the entire piece.

The server then encodes the acoustic waveform into a digital music file using an encoding component. The encoding component may implement a standardized acoustic data format such as a pulse-code modulation format or a compressed format using a psychoacoustic model. The encoder receives the raw waveform samples and outputs a sequence of encoded frames together with header metadata such as sampling rate, bit rate, and channel configuration. The resulting digital music file is stored on a storage device, for example a block storage volume or an object storage service, with a file identifier.

The server associates each digital music file with identification information and attribute information, which may include a unique song identifier, user identifiers, timestamps, genre labels, detected tempo, and key. This association is stored in a data management subsystem.

The server generates distribution information for each digital music file. The distribution information may include a network location identifier, such as a uniform resource locator, and access control data such as authentication tokens or permission flags. By storing these associations, the server enables external terminals to access the digital music files securely and efficiently.

The server accumulates record information describing correspondence among the basic data, the prompt sentence, the generative AI model identification information, and the resulting digital music file. The server maintains these records in a database with indexed fields allowing queries by user, by model version, by music type, or by timestamp. The server uses the record information to reconstruct the generation history of music, which supports regeneration or modification of existing works. For instance, if a user requests a modified version of a previously generated song, the server retrieves the basic data and prompt sentence associated with the original song and constructs a new prompt sentence that references the prior work. This capability allows the server to avoid reprocessing raw audio and transcription from scratch, thereby reducing computational load and network traffic.

The terminal accesses the distribution information from the server in response to user requests. The terminal requests streaming or download of a selected digital music file by sending the song identifier or a location obtained from the server. The terminal receives the digital music file over the network and decodes the file using an audio decoder provided by the operating system or an application library. The terminal controls playback through its audio output hardware, such as speakers or headphones. The user hears the generated song and may issue further requests, such as editing or regeneration.

In another embodiment, the server provides the underlying music information in an editable information format to an external apparatus. The editable information format may be a symbolic representation including notes, chords, tempo changes, and structural markers. The external apparatus may be a digital audio workstation or a specialized editing tool. The server transmits the music information to the external apparatus along with model identification and record information. The external apparatus allows the user to modify the symbolic music information, such as changing chords, adjusting melody lines, or altering arrangement parameters. The user then instructs the server, via the external apparatus or the terminal, to regenerate a digital music file from the edited symbolic information. The server uses the same synthesis and encoding processes to produce a new digital music file, which is stored with updated record information.

The described architecture provides improvements in computer technology that go beyond mere automation of human creative work. By integrating multiple input modalities into basic data, the server reduces redundancy and enforces a uniform internal structure, which enhances caching and retrieval efficiency. The explicit construction of prompt sentences based on structured basic data, emotion descriptors, and structural markers allows the generative AI model to receive a more informative and constrained input, which reduces the number of generation attempts required to obtain satisfactory results. This reduces computational load in the model-serving infrastructure and lowers network usage.

The server's use of a generative AI model with a defined neural network architecture, explicit feature representations, and specific decoding strategies yields technical effects in terms of accuracy and reproducibility. For example, by employing a transformer-based architecture with self-attention layers that can model long-range dependencies between lyrical phrases and musical sections, the system improves alignment between text segments and musical structure compared to earlier recurrent architectures. The attention-based mechanism allows the model to reference non-adjacent tokens efficiently, which in turn enhances the coherence and emotional consistency of the generated music. The server's training of the generative AI model using a loss function defined over both symbolic accuracy and structural metrics, and by using mini-batch gradient descent with adaptive learning-rate algorithms, results in model parameters that produce more stable outputs, reducing variance between generations given similar input prompts.

The server applies specific training methods, such as data augmentation on symbolic music sequences (for example, transposition to different keys, tempo scaling, and random section reordering within constraints) to increase robustness. The training process uses a cross-entropy loss for token prediction combined with auxiliary losses that encourage structurally valid section boundaries and chord progressions. During training, the server updates weights using backpropagation and an optimizer such as an adaptive moment estimation variant.

These methods improve generalization performance and reduce the rate of structural errors in the generated music.

The system's record information and generation history management further improve computer performance by allowing efficient reuse of intermediate results. Instead of re-performing speech recognition, sentiment analysis, and prompt construction from original raw data every time a user requests a variation, the server retrieves and modifies existing basic data and prompt sentences. This leads to lower latency for regeneration operations and reduced utilization of computational resources, especially in high-traffic environments. The structured record information also allows the server to perform batch processing and prefetching optimizations, since it can identify popular model versions and frequently reused basic data patterns.

In alternative embodiments, the server may utilize different generative AI model structures, such as a latent diffusion model operating on symbolic music representations, or a hybrid architecture combining a graph neural network for chord progression planning with a transformer for melody generation. The server may also vary the speech recognition technique, using end-to-end encoder-decoder architectures or hybrid models, and may choose different synthesis engines, such as physical modeling synthesizers or neural audio synthesizers. These variations still employ the same overall concept of integrating voice and text into basic data, constructing prompt sentences, and managing record information to improve computational efficiency and reproducibility.

By focusing on specific data structures (basic data, prompt sentence, model input information, symbolic music information, record information), explicitly defined processing modules (speech recognition, prompt construction, generative model inference, synthesis, encoding, storage, distribution), and detailed model architectures and training procedures, the system provides a concrete improvement in computer-based music generation. The server does not simply replace a human composer; instead, the server reorganizes and optimizes internal computation, reduces redundant processing, improves accuracy and stability of generative outputs, and enhances the ability of the computational system to manage, trace, and reuse complex multimedia data.

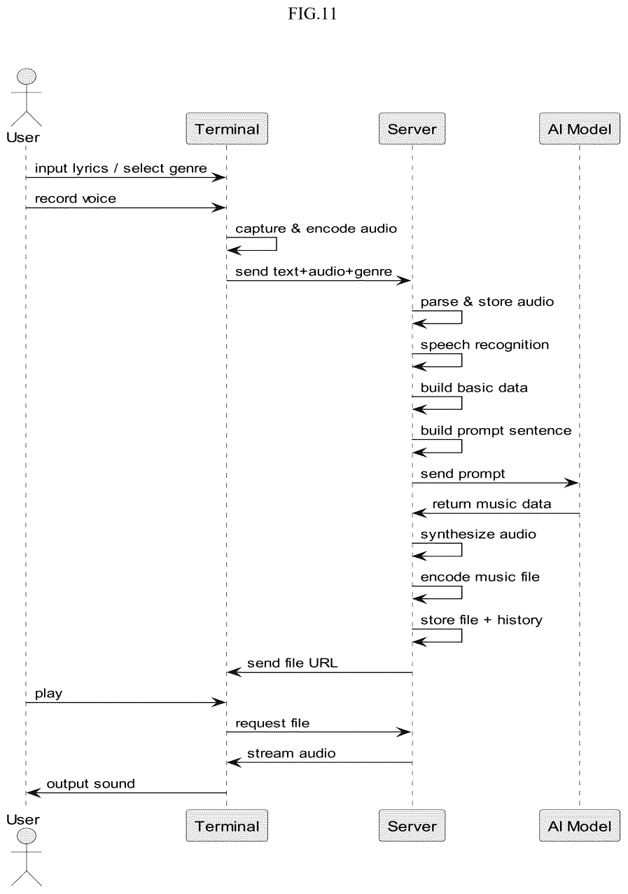

The following describes the processing flow using FIG. 11.

### Step 1:

The user operates the terminal to provide initial inputs. The user enters lyrics as character information into a text input field, activates a recording control, and sings or hums into a microphone of the terminal. The user also selects music type information, such as a genre, from a selection control. The input of this step is human voice and user interface actions, and the output is raw user text on the display and analog acoustic signals at the microphone.

### Step 2:

The terminal converts the analog acoustic signals into digitized audio data. The terminal samples the microphone signal at a predetermined sampling rate and quantization depth, applies optional preprocessing such as normalization and noise reduction, and encodes the resulting data into an audio format. The input of this step is the analog acoustic waveform from the microphone, and the output is a digital audio stream buffered in memory or stored as an audio file.

### Step 3:

The terminal constructs a request data structure containing the user's character information, the encoded digital audio data, and the selected music type information, and transmits this structure to the server. The terminal serializes the data, for example as key-value pairs, adds identifiers such as a session ID, and sends it over a network using a communication protocol.

The input of this step is the digital audio stream, the text lyrics, and the selected music type, and the output is a network request message delivered to the server.

### Step 4

The server receives the network request and parses the included data. The server reads the message headers and body, separates the audio portion, the character information portion, and the music type information portion, and verifies basic constraints such as allowed file size and valid genre values. The input of this step is the serialized request message, and the output is internal variables or records containing raw audio data, user text, and music type information stored in server memory.

### Step 5:

The server stores the raw audio data and associated metadata. The server writes the audio data to a storage device, such as a file system or object store, and inserts metadata entries including a request identifier, a user identifier, and timestamps into a data management system. The input of this step is the parsed audio data and metadata, and the output is a stored audio object and a corresponding metadata record.

### Step 6:

The server performs speech recognition on the user voice information and melody information represented by voice. The server invokes a speech recognition component that transforms the audio into feature vectors, such as spectral coefficients, and processes them through an acoustic and language model. The input of this step is the stored or buffered audio data, and the output is a transcription result containing recognized character sequences and optional timing or confidence information.

### Step 7:

The server normalizes and cleans the recognized character sequences. The server removes filler tokens, merges repeated characters, and segments the recognition output into meaningful units, such as words or phrases, using string processing functions. The input of this step is the raw recognition result, and the output is normalized recognized character information.

### Step 8:

The server integrates the normalized recognized character information with the user-supplied character information into basic data. The server creates or updates a structured record that includes fields for user lyrics, recognized text from humming or singing, music type information, and control parameters. The input of this step is the normalized recognized text, the original user text, and the music type information, and the output is basic data stored in server memory and optionally persisted.

### Step 9:

The server derives emotion and structure information from the basic data. The server may apply a sentiment analysis model to the lyrics to classify emotional tone and may assign structural labels such as verse and chorus based on text order and user markers. The input of this step is the basic data, and the output is a set of emotion descriptors and structure labels associated with the basic data.

### Step 10:

The server constructs a prompt sentence for a generative AI model. The server uses a template or rule-based composition to embed the user lyrics, a description of the transcribed melody, the selected music type, and the derived emotion and structure information into a coherent natural language instruction. For example, the server may produce the following prompt sentence:

“Lyrics: ‘Love Song’. Melody: Use the melodic contour and rhythm implied by the user's humming (transcribed from the provided audio). Genre: Pop. Based on these inputs, generate a full pop song with a verse-chorus structure, a catchy main hook, and an arrangement suitable for streaming platforms.”

The input of this step is the basic data together with emotion and structure information, and the output is a text string representing the prompt sentence.

### Step 11:

The server builds model input information from the prompt sentence and control parameters.

The server combines the prompt sentence with numeric parameters such as desired length, tempo range, and sampling parameters into a structured model input object suitable for the generative AI model interface. The input of this step is the prompt sentence and optional control settings, and the output is model input information ready for inference.

### Step 12:

The server transmits the model input information to the generative AI model and executes inference. The server converts the prompt sentence into tokens, applies an embedding function, and forwards the embeddings and control values to a neural network model, such as a transformer-based sequence generator. The model computes attention weights, hidden states, and output token probabilities layer by layer. The input of this step is the model input information, and the output is a sequence of generated tokens representing music information.

### Step 13:

The server decodes the generated tokens into symbolic music information. The server maps each token to a musical event or structural element using a predefined vocabulary, constructs sequences of notes, chords, and section markers, and validates timing consistency. The input of this step is the token sequence from the generative AI model, and the output is symbolic music information, such as note events with pitch, duration, and instrument attributes.

### Step 14:

The server determines whether waveform information is already available or must be synthesized. When the generative AI model directly outputs waveform samples, the server treats them as waveform information; otherwise, the server identifies that only symbolic information exists and triggers a synthesis process. The input of this step is the symbolic music information and any waveform output from the model, and the output is a decision flag and the music information type.

### Step 15:

The server synthesizes waveform information from symbolic music information when necessary. The server passes the symbolic events to a synthesis engine, which generates digital audio samples for each note using algorithms such as sample playback or wavetable synthesis, and mixes the samples according to their timing and amplitude. The input of this step is the symbolic music information, and the output is a continuous acoustic waveform representing the generated song.

### Step 16:

The server encodes the acoustic waveform into a digital music file. The server segments the waveform into frames, applies an encoding algorithm corresponding to a standardized acoustic data format, and writes headers and metadata such as sampling rate and channel count. The input of this step is the acoustic waveform, and the output is a digital music file suitable for storage and playback.

### Step 17:

The server stores the digital music file and associates it with identification and attribute information. The server writes the file to a storage device and updates a data management system with a record containing the file identifier, the user identifier, the music type, and characteristics such as duration and creation time. The input of this step is the digital music file and associated metadata, and the output is a persisted file and a management record.

### Step 18:

The server generates distribution information enabling access to the digital music file. The server constructs a network resource identifier, such as a URL, and embeds access control data, such as authorization tokens or permission flags, into a distribution descriptor. The input of this step is the stored file identifier and management record, and the output is distribution information that can be returned to terminals.

### Step 19:

The server records the correspondence among the basic data, the prompt sentence, the generative AI model identification, and the digital music file as record information. The server creates or updates a generation history entry that links input conditions to output files using relational keys or indices. The input of this step is the basic data, the prompt sentence, the model identification, and the file identifier, and the output is a stored generation history entry.

### Step 20:

The server transmits response data containing distribution information and relevant metadata to the terminal. The server packages the access link, song identifiers, and attributes into a response message and sends it over the network using the communication protocol. The input of this step is the distribution information and metadata, and the output is a response message delivered to the terminal.

### Step 21:

The terminal receives the response data and prepares for playback or download. The terminal parses the response, extracts the distribution information, and configures an audio playback component with the provided network resource identifier. The input of this step is the response message from the server, and the output is an initialized playback state ready to access the digital music file.

### Step 22:

The user controls playback and interaction with the generated music on the terminal. The user selects play, pause, or download controls, and the terminal accordingly requests streaming or file transfer from the server, decodes the received digital music file, and outputs sound through speakers or headphones. The input of this step is the distribution information and user control actions, and the output is audible playback of the generated song and, when requested, a stored copy of the file on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented music creation systems suffer from several technical limitations in how user-provided audio and text inputs are processed and transformed into production-ready musical content. In typical systems, user voice recordings, humming-based melody inputs, and lyric text are handled in a fragmented manner by separate software tools or services. As a result, low-level audio signal processing, natural language processing, and automatic music arrangement often operate in isolation, leading to suboptimal utilization of computational resources and inconsistent use of intermediate data representations.

Specifically, when a user provides humming as a melody indication, existing systems frequently treat the audio merely as a raw reference for manual interpretation, rather than algorithmically extracting explicit melody feature information and rhythm feature information in a machine-usable format. This prevents efficient reuse of the same low-level feature data across downstream modules, such as automatic arrangement engines or generative models, and results in redundant computations, increased latency, and higher processor load. Likewise, lyric text input is often inserted into a composition as-is, without being automatically reshaped into a structure that is compatible with detected melody and rhythmic constraints, which leads to misalignment between text phrasing and musical structure and requires additional manual correction.

Moreover, known systems that invoke generative AI models for music generation typically send loosely structured prompts that do not reflect detailed, machine-derived feature information from the user's audio and text data. Without incorporating explicit melody feature information, rhythm feature information, and structured lyric information into a prompt sentence, the generative AI model tends to produce outputs that do not closely follow the user's melodic intent or timing and that are difficult to post-process automatically. This causes inefficiencies in regenerating partial sections of a song, such as modifying only a chorus or bridge, because the system must either regenerate the entire piece or rely on manual editing operations.

Additionally, many existing systems are not designed to maintain a unified, editable “music production data” representation in which arranged acoustic data, synthesized singing voice data, and editing metadata (such as time position information, section structure information, and volume information) are consistently associated and machine-operable. As a result, editing operations such as section deletion, section extension, structure change, or targeted regeneration of specific song segments are implemented in an ad-hoc manner, often requiring manual re-mixing or external digital audio workstation software. This fragmented architecture impedes efficient, iterative updates and makes it difficult to support automated re-rendering of only affected sections based on new instructions.

Furthermore, conventional systems do not sufficiently optimize the pipeline from user input, through feature extraction and generative model interaction, to final distribution-ready audio data storage and transmission. In particular, known approaches do not define a processor-level configuration that systematically: (i) extracts structured feature information from raw signals, (ii) composes prompt sentences for generative AI models using this structured information, (iii) converts generative outputs into standardized musical control data, and (iv) regenerates arranged acoustic data in a way that is tightly integrated with editing operations and distribution mechanisms. This leads to increased complexity in system integration, more network round trips, duplicated conversions between data formats, and degraded responsiveness of the overall system, especially in interactive editing scenarios on resource-constrained client terminals.

Accordingly, there is a need for an improved computer-implemented system that technically enhances the way a processor acquires, analyzes, and reuses user voice information, character string information, melody information, and music type information. Such a system should enable a processor to efficiently construct and update prompt sentences for a generative AI model based on structured feature information, to generate and maintain musical control data and arranged acoustic data in an editable and regenerable form, and to transform the resulting musical content into distribution-ready data while reducing computational overhead and improving responsiveness of the end-to-end music creation and distribution workflow.

The specific processing by the specific processing unit 290 of the data processing device 12 in Application Example 1 is realized by the following means.

The present invention provides a server comprising a processor configured to acquire, as input information, user voice information, character string information, melody information, and music type information from a terminal apparatus; to analyze the user voice information and the melody information in a time domain or a frequency domain by executing a signal processing program so as to extract melody feature information and rhythm feature information; to analyze the character string information by executing a natural language processing program to perform syntactic analysis and semantic analysis so as to generate shaped character string information suitable for a musical structure; to construct, in a natural language, a prompt sentence for input to a generative artificial intelligence model on the basis of the extracted melody feature information and the rhythm feature information, the shaped character string information, and the music type information; to supply the prompt sentence to the generative artificial intelligence model to obtain music design information including musical structure information, chord progression information, and arrangement instruction information; to generate musical description information including pitch information and time information on the basis of the obtained music design information; to execute a music encoding program that generates control information sequences using the musical description information so as to generate musical control data; to control an acoustic synthesis program or an acoustic synthesis apparatus on the basis of the musical control data so as to generate arranged acoustic data; to generate singing voice data by executing a speech synthesis program that uses the shaped character string information and the musical description information and uses the user voice information as speaker feature information, and to perform mixing processing of the singing voice data and the arranged acoustic data to generate user voice reproduction acoustic data; to output the arranged acoustic data and the user voice reproduction acoustic data as music production data in an editable format associated with editing information including time position information, section structure information, and volume information, and to enable the music production data to be updated in response to editing instructions from the terminal apparatus; and to store the music production data or final acoustic data generated on the basis of the music production data in an external storage apparatus, and to output, as distribution data, the final acoustic data stored in the external storage apparatus so as to be transmittable to a distribution management information processing apparatus via a communication network. This enables a technical improvement in computer-based music generation and editing by unifying low-level feature extraction, prompt sentence construction for a generative AI model, standardized musical control data generation, and distribution-oriented data handling in a single processor-controlled pipeline, thereby reducing redundant processing, improving responsiveness in partial regeneration and editing operations, and providing an efficient, machine-operable representation of musical content from initial user input through final distribution.

The term “user voice information” refers to digital audio data representing a user's spoken or sung voice, which is captured by an input transducer and used as a source of speaker-specific acoustic characteristics and/or content for subsequent processing.

The term “character string information” refers to text data composed of one or more characters, symbols, or words, including but not limited to lyrics and other textual content, which is provided as input for natural language analysis and musical structuring.

The term “melody information” refers to audio data, symbolic data, or other signal data that expresses a melodic sequence, such as humming or whistling, and that is used as a basis for extracting pitch and rhythm patterns.

The term “music type information” refers to classification data indicating a musical category, style, genre, or similar attribute, which constrains or guides the generation or arrangement of a musical piece.

The term “signal processing program” refers to executable instructions that, when executed by a processor, perform numerical operations on time-domain or frequency-domain representations of audio signals to derive analysis results such as spectral features, pitch, and timing.

The term “time domain” refers to a representation of an audio signal as a function of time, typically expressed as a sequence of sampled amplitude values.

The term “frequency domain” refers to a representation of an audio signal as a function of frequency, typically obtained by applying a transform such as a Fourier transform to time-domain data.

The term “melody feature information” refers to data that characterizes a melodic contour or structure, including but not limited to pitch trajectories, note sequences, key candidates, and related parameters derived from melody information.

The term “rhythm feature information” refers to data that characterizes temporal and rhythmic aspects of audio, including but not limited to tempo, beat positions, onset times, and rhythmic patterns.

The term “natural language processing program” refers to executable instructions that, when executed by a processor, perform operations such as tokenization, syntactic analysis, semantic analysis, and text transformation on character string information.

The term “syntactic analysis” refers to the processing of text to determine structural relationships among words or tokens, such as phrase boundaries and grammatical roles.

The term “semantic analysis” refers to the processing of text to infer meaning, intent, or contextual relationships, including the extraction of concepts, sentiment, or topics from character string information.

The term “shaped character string information” refers to text data that has been transformed or organized by natural language processing so as to conform to one or more constraints of a musical structure, such as verse-chorus segmentation, line lengths, or syllabic alignment.

The term “generative artificial intelligence model” refers to a computational model, typically trained on data using machine learning techniques, that produces output data such as text or symbolic music in response to input data, and that is capable of generating new content rather than only classifying or retrieving existing content.

The term “prompt sentence” refers to a text string formulated in a natural language and used as an input instruction or query to a generative artificial intelligence model to guide the model's output.

The term “music design information” refers to structured data describing the high-level organization and content of a musical piece, including but not limited to musical structure information, chord progression information, and arrangement instruction information.

The term “musical structure information” refers to data specifying the segmentation and ordering of sections within a musical piece, such as introductions, verses, choruses, bridges, and outros, and their temporal positions.

The term “chord progression information” refers to data specifying a sequence of harmonic entities, such as chords or tonal centers, arranged over time or over measures of a musical piece.

The term “arrangement instruction information” refers to data describing instrumentation, texture, dynamic levels, and other production-related parameters that define how a musical structure and harmony are realized in an arrangement.

The term “musical description information” refers to data that specifies musical events in terms of pitch information, time information, and optionally other attributes such as velocity or articulation, in a form suitable for converting into musical control data.

The term “pitch information” refers to data indicating the perceived frequency or note identity of a sound, typically represented as note numbers, frequencies, or scale degrees.

The term “time information” refers to data indicating temporal positions or durations of musical events, including absolute times, relative timings, or positions in a rhythmic grid or measure structure.

The term “music encoding program” refers to executable instructions that transform musical description information into a sequence of control messages or codes, such as note-on and note-off events, suitable for driving an acoustic synthesis program or apparatus.

The term “control information sequences” refers to ordered sets of control data items, such as messages or events, that define how an acoustic synthesis process or apparatus should produce or modify sound over time.

The term “musical control data” refers to data derived from musical description information and formatted as control information sequences, which specify the behavior of one or more sound generation or processing components.

The term “acoustic synthesis program” refers to executable instructions that, when executed by a processor, generate audio waveforms or process audio signals according to musical control data.

The term “acoustic synthesis apparatus” refers to hardware, firmware, or a combination thereof that generates or processes audio signals under control of musical control data.

The term “arranged acoustic data” refers to digital audio data representing a rendered musical arrangement, generated by applying musical control data to an acoustic synthesis program or apparatus.

The term “speech synthesis program” refers to executable instructions that generate speech or singing voice audio from text and optional speaker feature information.

The term “speaker feature information” refers to data representing acoustic characteristics of a speaker's voice, such as timbre, pitch range, or prosodic patterns, used to synthesize voice similar to that speaker.

The term “singing voice data” refers to digital audio data representing a synthesized or processed vocal performance aligned with a musical structure.

The term “user voice reproduction acoustic data” refers to digital audio data generated by mixing singing voice data, which reflects user-specific speaker characteristics, with arranged acoustic data, such that the result appears as a musical performance by the user.

The term “music production data” refers to a data set that includes at least arranged acoustic data, user voice reproduction acoustic data, and associated metadata, and that is structured to support editing and regeneration of a musical piece.

The term “editing information” refers to metadata including, but not limited to, time position information, section structure information, and volume information, which defines how music production data may be modified or rendered.

The term “time position information” refers to data indicating specific temporal locations within audio or musical structures, such as start times, end times, or segment boundaries.

The term “section structure information” refers to data indicating the identity, order, and relationships of sections within a musical piece, such as mapping time intervals to section labels.

The term “volume information” refers to data indicating gain or loudness levels for overall audio, specific tracks, or segments, used to control perceived amplitude.

The term “editable format” refers to a data representation that allows programmatic modification of musical content or parameters, including insertion, deletion, or alteration of segments or attributes, without requiring full manual reconstruction.

The term “terminal apparatus” refers to an end-user computing device, such as a mobile device, tablet, or personal computer, that provides user interfaces for input, playback, editing, and communication with a server.

The term “external storage apparatus” refers to a storage system separate from the processor executing the main control logic, such as a remote storage service, network storage, or other non-volatile memory device accessible over a communication interface.

The term “distribution data” refers to digital audio data and associated metadata formatted for transmission and use by a distribution management information processing apparatus, such as a streaming or download platform.

The term “distribution management information processing apparatus” refers to a computing system that receives, stores, manages, or distributes digital audio content to end users over a communication network.

The term “communication network” refers to any wired or wireless network infrastructure, including local area networks, wide area networks, and public networks, that enables data exchange between a server, terminal apparatus, and other systems.

The term “editing processing program” refers to executable instructions that modify musical description information, musical control data, or related metadata according to editing information, and that cause re-generation of arranged acoustic data or user voice reproduction acoustic data.

The term “additional expression instruction information” refers to user-provided data that specifies desired changes in musical or expressive characteristics, such as intensity, emotional tone, or arrangement emphasis, for all or part of a musical piece.

The term “partial section of a musical piece” refers to a subset of the temporal extent or structural elements of a musical work, such as a specific verse, chorus, bridge, or any defined time interval.

The term “regenerated music design information” refers to updated music design information produced by re-invoking a generative artificial intelligence model using a new prompt sentence, typically targeted to a partial section of a musical piece.

In an embodiment, a server, a terminal, and a user cooperate to implement the invention. The server includes at least one processor, a main memory, a non-volatile storage device, and a network interface. The terminal includes at least one processor, a memory, a display, an input interface, an audio input unit, and an audio output unit. The user operates the terminal to provide voice, melody, and text inputs. The server executes software modules including a signal processing program, a natural language processing program, a generative AI model interface program, a music encoding program, an acoustic synthesis program, a speech synthesis program, an editing processing program, and a distribution interface program.

The terminal executes an application program that runs on a general-purpose computing device such as a smartphone, tablet, or personal computer. The terminal includes an audio input unit such as a built-in microphone connected to an analog-to-digital converter, and the terminal uses an operating system-provided audio capture framework (for example, an audio capture library in a mobile operating system) to obtain digital audio samples. The terminal records user voice information and melody information as digital audio files in a linear pulse code modulation format or a compressed audio format and stores them in a local file system or local database. The terminal also accepts character string information as user input via a graphical user interface and stores the character string information as a text string in a device-local data structure. The terminal transmits these data to the server via a communication network using a secure transport protocol.

The server stores the received user voice information and melody information in a non-volatile storage device and loads corresponding audio samples into the main memory when processing is performed. The server executes a signal processing program that is implemented, for example, by an audio analysis library configured to operate on discrete-time sampled waveforms. The server uses the signal processing program to perform a series of numerical operations including windowing, discrete Fourier transform, and spectral feature extraction. The server computes a time-frequency representation such as a spectrogram or mel-frequency spectrogram and uses peak-picking, pitch-tracking, and onset-detection algorithms to derive melody feature information and rhythm feature information.

The server uses the melody feature information to construct a symbolic representation of the melody information, for example as a sequence of pitch values indexed by time indices or beats, and uses rhythm feature information to determine tempo, beat locations, and rhythmic grouping. The server stores melody feature information and rhythm feature information in structured data objects, such as arrays or lists of tuples containing pitch and timing parameters. The server thus converts raw waveform data into a compact, machine-readable representation that can be repeatedly reused without re-executing the computationally expensive transforms, thereby improving processing speed and reducing redundant computations during iterative editing or regeneration.

The server uses a natural language processing program to analyze the character string information. The server tokenizes the character string information into words or sub-word units, performs part-of-speech tagging and syntactic parsing using a statistical or neural parser, and applies a semantic analysis module to extract sentiment, topical information, and phrase boundaries. The server then reorders or segments the character string information into shaped character string information aligned with an implicit musical structure, for example mapping lines or phrases to verse and chorus segments and adjusting line lengths to match typical bar lengths derived from rhythm feature information. The server stores shaped character string information in a structured format with explicit mapping between text segments and musical sections.

The server constructs a prompt sentence for a generative AI model using the melody feature information, the rhythm feature information, the shaped character string information, and the music type information. The server forms the prompt sentence as a natural-language sequence of tokens that encodes, in text form, the numeric and structural information derived from audio and text analysis. In an embodiment, the server generates a prompt sentence such as:

“Create a pop song with the following lyrics: ‘Song of Love’. The melody should be based on the user's humming and should have a cheerful and upbeat tone.”

In a further embodiment, the server uses a more structured prompt sentence such as: “Create a pop song with the following lyrics: ‘Song of Love’. The melody should be based on the user's humming (melodic contour extracted from the audio), with a tempo around 120 BPM and a key close to C major. The arrangement should be cheerful and upbeat, using drums, bass, acoustic guitar, plano, and a bright synth lead for the chorus. Output a detailed description of the melody, chord progression, and arrangement structure (intro, verse, pre-chorus, chorus, bridge, outro), and refine the lyrics so they fit naturally into this structure.”

The server may also use a prompt sentence including explicit numeric descriptors derived from the signal processing program, such as pitch ranges, bar counts, and section durations.

The server thereby converts intermediate feature data into a text-based control structure for a generative AI model in a non-conventional way that tightly couples signal-derived information with language instructions. This bridging of signal-level features and text instructions allows the generative AI model to leverage specific, machine-extracted details that are not typically available in conventional, manually written prompts.

The server implements the generative AI model as a trained neural network architecture configured to map prompt sentences into music design information. In one embodiment, the generative AI model is a transformer-based sequence model including stacked self-attention layers, feedforward layers, and positional encodings. The server maintains model parameters comprising weight matrices and bias vectors trained on a corpus of musical descriptions and corresponding symbolic music annotations. The server stores the model parameters in non-volatile storage and loads them into memory for inference. The server performs inference by applying matrix multiplications and non-linear activation functions to the tokenized prompt sentence, thereby generating output tokens representing musical structure information, chord progression information, and arrangement instruction information.

The server uses a specific loss function, such as a cross-entropy loss over predicted tokens of musical annotations during training, to optimize the generative AI model. The server updates model parameters during training by applying a gradient-based optimization method, such as stochastic gradient descent with adaptive learning rates, using backpropagation. The server optionally applies data augmentation techniques during training, such as transposing chord progressions, time-scaling rhythmic patterns, and rephrasing textual descriptions, to increase robustness and generalization. Although training may be performed offline on a separate system, the server may also support incremental fine-tuning using user-specific interaction logs.

The server processes the generative AI model output by parsing the sequence of tokens into structured music design information. The server identifies musical sections, associated chord progressions, and arrangement directives. For example, the server parses tokens indicating “Intro: 4 bars, chords C-G-Am-F; Verse: 8 bars, chords C-Am-F-G; Chorus: 8 bars, chords F-G-Em-Am,” and tokens specifying instruments such as drums, bass, guitar, and plano. The server stores the resulting music design information in data structures that explicitly link section labels to chord progressions and intended instrumentation.

The server generates musical description information from the music design information by mapping symbolic chord labels and melodic descriptors into pitch information and time information. The server uses a rule-based mapping or learned mapping to convert chord names and scale degrees into concrete pitch values, taking into account the key determined from melody feature information. The server assigns start times and durations to each musical event based on bar counts, tempo, and rhythm feature information. The server forms a time-ordered list of note events, each event including at least pitch information and time information, and possibly additional attributes such as velocity.

The server executes a music encoding program that converts musical description information into musical control data. The server implements the music encoding program using a set of deterministic rules that generate control information sequences, such as note-on and note-off events, controller change events, and tempo change messages. The server organizes these control events into one or more tracks, with each track corresponding to a logical instrument in the arrangement. The server thus obtains musical control data in a format that can be directly consumed by an acoustic synthesis program or acoustic synthesis apparatus.

The server generates arranged acoustic data by executing an acoustic synthesis program or controlling an acoustic synthesis apparatus according to the musical control data. The server may use a software synthesizer that implements digital signal processing routines such as oscillators, filters, envelopes, and effects, or may control a hardware sound module. The server feeds the musical control data into the synthesizer, which produces digital audio samples that form the arranged acoustic data. The server can apply mixing and basic mastering algorithms, such as dynamic range compression and equalization, to improve sonic quality. The server stores the arranged acoustic data as a digital audio file in a non-volatile storage device and maintains an association between the arranged acoustic data and the underlying musical control data and music design information.

The server generates singing voice data using a speech synthesis program configured as a neural text-to-speech model. The server uses the shaped character string information and the musical description information to align syllables or phonemes with note events. The server extracts speaker feature information from the user voice information using a speaker embedding network that maps voice segments into a low-dimensional vector encoding. The server feeds shaped character string information and speaker feature information to a neural acoustic model, for example a sequence-to-sequence model generating mel-spectrograms, and then uses a neural vocoder model configured as a convolutional or autoregressive network to generate waveform samples from the spectrogram. The server thus produces singing voice data that follows the generated melody and retains acoustic characteristics of the user's voice.

The server performs mixing of singing voice data and arranged acoustic data using a digital mixing engine. The server aligns singing voice data and arranged acoustic data in time based on the musical description information and adjusts gain, panning, and effects to create a balanced mix. The server outputs user voice reproduction acoustic data as a digital audio stream or file. The server can store both arranged acoustic data and user voice reproduction acoustic data, and the server links these audio streams to editing information that describes how these data can be altered or re-generated.

The server outputs music production data that includes arranged acoustic data, user voice reproduction acoustic data, musical control data, music design information, and editing information. The server defines editing information as a set of data structures including time position information, section structure information, and volume information. The server associates each musical section and audio segment with unique identifiers and maintains an index of their temporal positions. The server thereby enables non-destructive editing: when editing information changes, the server can regenerate only affected segments of arranged acoustic data or singing voice data by re-executing the music encoding program, acoustic synthesis program, and speech synthesis program on partial musical control data. This architecture improves computational efficiency compared to systems that recompute entire audio files for every edit.

The terminal receives music production data from the server and stores it locally as a project.

The terminal displays section structure information to the user as labeled regions on a timeline. The user manipulates these regions (for example, shortening an introduction or repeating a chorus) by touch operations. The terminal transmits modified editing information to the server. The server executes an editing processing program that uses the modified editing information to adjust musical description information and musical control data. For example, the server deletes control events corresponding to a removed section or duplicates events for a repeated section. The server then re-synthesizes only the modified parts of arranged acoustic data and user voice reproduction acoustic data. This selective regeneration reduces processing time and network transmission volume, enabling faster interactive editing compared to conventional full-track re-rendering.

The server can also receive additional expression instruction information from the terminal, such as “make the chorus more powerful” or “reduce the intensity of drums in the verse.” The server converts additional expression instruction information into a structured representation and constructs a new prompt sentence that includes both original music design information and the additional constraints. The server sends the new prompt sentence to the generative AI model and obtains regenerated music design information for specific sections. Because the server restricts regeneration to selected sections and because the server reuses previously computed melody feature information and rhythm feature information, the server reduces unnecessary computations while still accommodating user-requested expressive changes.

The server stores music production data and final acoustic data in an external storage apparatus such as a remote storage system accessible via a network. The server manages metadata that associates final acoustic data with user identifiers, project identifiers, and distribution parameters. The server outputs distribution data to a distribution management information processing apparatus over a communication network. The distribution management information processing apparatus may be a streaming platform or content delivery system that receives encoded audio streams and associated metadata and distributes them to downstream clients.

The server improves computer technology by defining specific data structures for melody feature information, rhythm feature information, shaped character string information, music design information, musical description information, musical control data, arranged acoustic data, singing voice data, user voice reproduction acoustic data, music production data, and editing information, and by specifying a pipeline that minimizes redundant transformations and supports partial regeneration. The combination of feature extraction, generative AI model-based design, control-data-based synthesis, and editing-aware regeneration is not a mere automation of human music composition but introduces non-conventional, computer-specific optimizations.

The server reduces processing latency and CPU utilization by (i) caching melody feature information and rhythm feature information to avoid repeated spectral analysis, (ii) encoding music design information in a symbolic, control-oriented form rather than directly editing audio waveforms, and (iii) limiting re-synthesis to sound segments directly impacted by edits.

The server improves accuracy and consistency by grounding generative outputs in machine-extracted features instead of relying solely on loosely specified human prompts. The server decreases network load by transmitting high-level editing information and section identifiers instead of repeatedly transmitting entire audio files for every small change.

The generative AI model uses a structured training procedure that includes the use of feature-based prompts that incorporate pitch and timing patterns; therefore, the model learns alignment between text, symbolic music, and audio-derived descriptors. This training pipeline enables the model to generate music design information that more closely corresponds to user-supplied audio and text inputs than conventional generative models trained on text alone. By constraining the generative AI model output to a data schema that the music encoding program can directly consume, the server reduces the need for ad-hoc post-processing.

Alternative embodiments are possible. The server may implement different neural network architectures for the generative AI model, such as recurrent neural networks, convolutional networks with attention, or hybrid models. The server may implement the speech synthesis program using parametric, concatenative, or purely neural methods, and may derive speaker feature information from short voice samples or long recordings. The server may use different acoustic synthesis techniques, such as sample-based synthesis, physical modeling synthesis, or granular synthesis, and may generate multiple versions of arranged acoustic data with different instrument selections.

The terminal may be implemented as a desktop computer with more substantial local processing resources, and in such an embodiment, part of the signal processing program or acoustic synthesis program can be executed locally on the terminal to reduce network usage.

The server may also operate in a distributed configuration, with separate computing nodes dedicated to feature extraction, generative AI inference, and audio synthesis, connected via a high-speed data bus or network.

The system as a whole, comprising the server, the terminal, and the user interactions, thus provides a concrete and technically specific implementation for generating, editing, and distributing music content. The server transforms raw audio and text inputs into a multi-level internal representation that supports efficient control of synthesis apparatus and high-fidelity audio generation. The server uses computer-specific structures and algorithms, including learned neural models and deterministic encoding rules, to achieve improved processing speed, enhanced alignment accuracy between lyrics and melody, reduced network and memory overhead during editing, and reduced error rates in repeated regeneration compared to conventional systems.

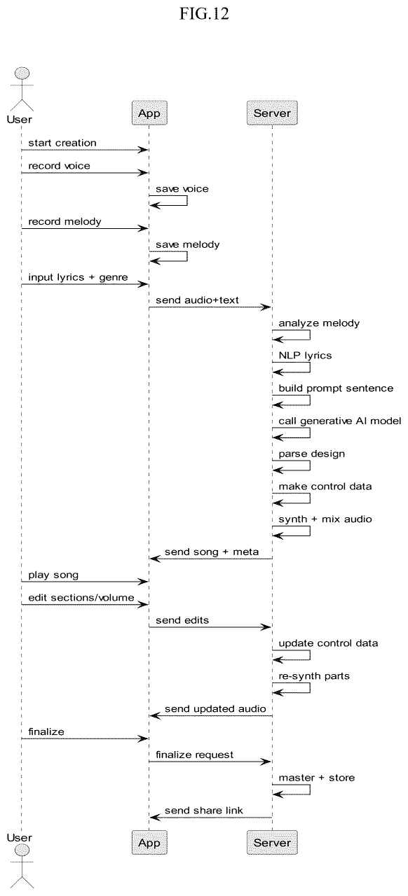

The following describes the processing flow using FIG. 12.

### Step 1:

The user operates the terminal to launch an application and select a new music creation function.

The terminal displays input controls for recording user voice information and melody information, and for entering character string information and music type information.

Input: No prior data; the terminal waits for user interactions.

Output: A user interface state ready to receive audio and text input.

### Step 2:

The user speaks or sings into the terminal's microphone to provide user voice information.

The terminal uses an audio capture framework to sample the analog voice signal at a predetermined sampling rate and bit depth, and stores the resulting digital samples in a buffer.

The terminal writes the buffered samples to a local audio file representing user voice information in a standard audio format.

Input: Analog audio signal from the user's voice.

Output: A digital audio file containing user voice information.

### Step 3:

The user performs humming or other melodic vocalization into the terminal's microphone to provide melody information.

The terminal again uses the audio capture framework to convert the analog melody signal into digital samples and stores them in a separate audio file.

The terminal tags this file as melody information distinct from general user voice information.

Input: Analog audio signal representing humming-based melody.

Output: A digital audio file containing melody information.

### Step 4:

The user enters lyrics or other text as character string information using the terminal's text input interface.

The terminal stores the entered text as a character string in memory and associates it with the current music creation session.

The user selects a desired music type information value, such as a genre, using a menu or list control, and the terminal stores this selection as a symbolic label.

Input: Keyboard or touch input representing characters and a selection of music type.

Output: Stored character string information and music type information associated with the session.

### Step 5:

The terminal aggregates user voice information, melody information, character string information, and music type information into a structured request.

The terminal encapsulates references to the audio files and text values in a data structure and serializes the structure for network transmission.

The terminal transmits this structured request to the server via a communication network using a secure protocol.

Input: Local audio files and text values stored on the terminal.

Output: A network message containing input information delivered to the server.

### Step 6:

The server receives the network message and parses the structured request to extract user voice information, melody information, character string information, and music type information.

The server stores the extracted audio files in a non-volatile storage device and loads them into memory as digital sample arrays.

Input: Serialized request from the terminal.

Output: In-memory representations of audio signals and text data ready for processing.

### Step 7:

The server executes a signal processing program on the melody information to derive melody feature information and rhythm feature information.

The server computes a time-domain or frequency-domain representation by applying windowing and spectral transforms and then runs pitch-tracking and onset detection algorithms to determine note pitches, note onsets, tempo, and beat positions.

The server aggregates the detected pitches and timings into a structured data set describing melodic contour and rhythmic pattern.

Input: Digital audio samples of melody information.

Output: Melody feature information and rhythm feature information stored in data structures.

### Step 8:

The server optionally applies the signal processing program to user voice information to extract speaker feature information for later use in voice synthesis.

The server segments the user voice signal, computes acoustic descriptors such as spectral envelopes and fundamental frequency, and feeds these descriptors into a speaker embedding model to obtain a vector representing user-specific vocal characteristics.

Input: Digital audio samples of user voice information.

Output: Speaker feature information encoded as a numerical vector.

### Step 9:

The server executes a natural language processing program on the character string information to generate shaped character string information suitable for musical structuring.

The server tokenizes the text, performs syntactic and semantic analysis, and detects phrase boundaries and sentiment.

The server segments lines into verse, pre-chorus, and chorus candidates and adjusts or annotates the text so that segment lengths better match typical bar and phrase lengths inferred from rhythm feature information.

Input: Character string information and, optionally, rhythm feature information.

Output: Shaped character string information that includes text segments aligned with potential musical sections.

### Step 10:

The server constructs a prompt sentence for a generative AI model by combining melody feature information, rhythm feature information, shaped character string information, and music type information into a natural-language instruction.

The server converts numerical features, such as tempo and key, into text phrases and embeds the user's lyrics and genre choice into a coherent description.

For example, the server constructs a prompt sentence such as:

“Create a pop song with the following lyrics: ‘Song of Love’. The melody should be based on the user's humming and should have a cheerful and upbeat tone.”

Input: Melody feature information, rhythm feature information, shaped character string information, and music type information.

Output: A text string forming a prompt sentence for the generative AI model.

### Step 11:

The server tokenizes the prompt sentence and inputs the resulting token sequence into a generative AI model implemented as a neural network.

The server performs forward propagation through multiple model layers, including embedding layers, attention layers, and feedforward layers, to compute output token probabilities.

The server samples or selects output tokens from these probabilities to obtain a sequence representing music design information, including musical structure information, chord progression information, and arrangement instruction information.

Input: Tokenized prompt sentence.

Output: Music design information encoded as a structured token sequence.

### Step 12:

The server parses the token sequence produced by the generative AI model into internal data structures representing music design information.

The server identifies labeled sections, associated chord progressions, and arrangement directives such as instrument assignments and dynamic levels, and stores these elements in tables indexed by section identifiers.

The server thus converts an unstructured token sequence into explicit representations usable by subsequent modules.

Input: Token sequence representing music design information.

Output: Structured music design information including section definitions, chord progressions, and arrangement instructions.

### Step 13:

The server generates musical description information by mapping music design information into concrete pitch information and time information.

The server assigns specific pitches to chords and melody lines based on key and scale choices inferred from melody feature information, and calculates note onset times and durations from bar counts, tempo, and rhythm feature information.

The server assembles a list of musical events, each event including at least a pitch value and timing parameters, and stores these events in ordered lists by track.

Input: Music design information, melody feature information, and rhythm feature information.

Output: Musical description information comprising event-level pitch and time data.

### Step 14:

The server executes a music encoding program that converts musical description information into musical control data.

The server iterates over musical events, generates corresponding note-on and note-off control messages, sets channel and track identifiers, and optionally inserts controller and tempo messages.

The server organizes these messages into control information sequences that can be interpreted by an acoustic synthesis program or apparatus.

Input: Musical description information.

Output: Musical control data representing control information sequences.

### Step 15:

The server generates arranged acoustic data by applying musical control data to an acoustic synthesis program or acoustic synthesis apparatus.

The server sends control messages to synthesis routines that generate waveform samples for each instrument track, sums the resulting audio streams, and applies optional processing such as equalization and compression.

The server writes the resulting digital audio stream to a storage medium as arranged acoustic data.

Input: Musical control data.

Output: Arranged acoustic data stored as a digital audio representation of the musical arrangement.

### Step 16:

The server generates singing voice data using a speech synthesis program that takes shaped character string information, musical description information, and speaker feature information as input.

The server aligns text phonemes with note events from musical description information, predicts an acoustic representation such as a mel-spectrogram using a neural acoustic model, and converts this representation to waveform samples using a vocoder.

The server produces a time-aligned vocal track that follows the melody and retains the user's vocal characteristics.

Input: Shaped character string information, musical description information, and speaker feature information.

Output: Singing voice data as a digital audio stream.

### Step 17:

The server mixes singing voice data and arranged acoustic data to generate user voice reproduction acoustic data.

The server synchronizes both audio streams using time information, applies gain settings and panning, and may apply additional effects such as reverb to achieve a desired balance.

The server outputs a mixed audio file that contains the combined instrumental and vocal performance.

Input: Arranged acoustic data and singing voice data.

Output: User voice reproduction acoustic data representing a mixed song.

### Step 18:

The server assembles music production data by associating arranged acoustic data, user voice reproduction acoustic data, musical control data, music design information, and editing information.

The server creates editing information that includes time position information, section structure information, and volume information, and links these to specific segments of audio and control data using identifiers and time indices.

The server stores music production data in a format that supports non-destructive editing and partial regeneration.

Input: Arranged acoustic data, user voice reproduction acoustic data, musical control data, and music design information.

Output: Music production data that encapsulates audio assets and related metadata.

### Step 19:

The server transmits music production data or a subset of it to the terminal.

The terminal receives the data, stores audio files locally, and builds a project state including section markers, volume curves, and references to arranged and mixed tracks.

The terminal generates a user interface that visualizes the section structure and playback position.

Input: Music production data from the server.

Output: Local project data on the terminal and a visual editing environment displayed to the user.

### Step 20:

The user reviews the generated song by operating playback controls on the terminal.

The terminal reads arranged acoustic data or user voice reproduction acoustic data, controls an audio output unit to play the sound, and updates a visual playback cursor in synchronization with audio.

The user evaluates the timing, structure, and sound balance and decides whether to perform editing operations.

Input: Music production data stored on the terminal.

Output: Audible playback and visual feedback, enabling the user to determine edits.

### Step 21:

The user issues editing instructions through the terminal, such as trimming an introduction, repeating a chorus, or adjusting volume levels for specific sections.

The terminal converts user manipulations into updated editing information, including modified time position information, section structure information, and volume information, and sends this updated editing information to the server.

Input: User interactions on the editing interface.

Output: Updated editing information transmitted to the server.

### Step 22:

The server receives updated editing information and executes an editing processing program to modify musical description information and musical control data accordingly.

The server identifies which sections or time intervals are affected, deletes, duplicates, or repositions corresponding control events, and recalculates timing where necessary.

The server then regenerates only the affected parts of arranged acoustic data and user voice reproduction acoustic data by reapplying the acoustic synthesis program and speech synthesis program to the modified segments.

Input: Existing musical description information, musical control data, and updated editing information.

Output: Updated musical control data and partially regenerated arranged acoustic data and user voice reproduction acoustic data.

### Step 23:

The server updates music production data by replacing or augmenting previous audio segments and control data with regenerated versions, and by storing the latest editing information.

The server returns an updated version of music production data or updated audio segments to the terminal.

The terminal integrates the updated segments into the local project, enabling the user to audition the changes.

Input: Previous music production data and regenerated audio/control data.

Output: Updated music production data reflecting the user's edits.

### Step 24:

The user confirms completion of editing and issues an export or finalize instruction on the terminal.

The terminal sends a finalization request to the server, indicating that current music production data should be converted into final acoustic data for distribution.

The server aggregates all required arranged and mixed segments, applies final mastering adjustments, and generates a final audio file.

Input: Current music production data and a finalization instruction.

Output: Final acoustic data representing the completed song.

### Step 25:

The server stores the final acoustic data in an external storage apparatus and creates distribution data by associating the final acoustic data with distribution metadata such as title, artist identifier, and genre.

The server makes the distribution data available to a distribution management information processing apparatus via a communication network, optionally notifying the terminal of a resource identifier or link.

The terminal may display the link to the user, who can then share or otherwise use the distributed content.

Input: Final acoustic data and associated metadata.

Output: Distribution data stored externally and accessible for streaming or downloading.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional computer-implemented music production systems generally treat text generation, music arrangement, and voice synthesis as loosely coupled and manually orchestrated processes. A typical workflow requires a user to separately prepare lyrics, manually edit or structure those lyrics, independently arrange an accompaniment for a melody, and then either record vocals in real time or rely on generic text-to-speech engines that do not reflect the user's own voice characteristics. As a result, existing systems often suffer from low automation, significant latency due to manual intervention, and limited personalization of the final audio output.

From a computer technology standpoint, current architectures do not efficiently integrate: (i) generative artificial intelligence models driven by prompt sentences for shaping user-provided textual ideas into structured lyric data; (ii) algorithmic extraction of pitch and timing from user-provided humming to generate symbolic melody data and corresponding accompaniment based on codified music theory; and (iii) voice-cloning-based singing synthesis that uses user-specific acoustic features to produce a vocal track that is temporally and melodically aligned with arranged accompaniment. The lack of a unified processing pipeline leads to redundant data transformations, complex data exchange between heterogeneous subsystems, and suboptimal utilization of computing resources for real-time or near-real-time generation of personalized music content.

Additionally, many existing systems do not provide a consistent mechanism to derive machine-usable control information (e.g., time-aligned phoneme and pitch control data) that connects shaped lyric text with symbolic melody data. Without such intermediate singing control information, the underlying computing processes cannot reliably synchronize lyric syllables with musical notes, which leads to unnatural phrasing, timing errors, and additional manual correction. Furthermore, integration of distribution and editing workflows is often ad hoc, requiring external tools to upload generated content to delivery platforms or to expose intermediate, structurally meaningful data for further editing.

Accordingly, there is a need for an improved computer-based system and processing architecture that: (1) automatically converts user input in the form of voice, text, humming, and style parameters into machine-structured lyric, melody, and accompaniment data; (2) efficiently generates singing control information that aligns textual units with musical symbols; (3) synthesizes a singing audio signal reflecting user-specific voice characteristics; and (4) produces a mixed, encoded music audio signal that is both distribution-ready and optionally usable as structured editing data. Such an architecture should improve overall system throughput, reduce latency, and enhance personalization while enabling robust, automated processing on general-purpose computing hardware.

The specific processing by the specific processing unit 290 of the data processing device 12 in Example 2 is realized by the following means.

The present invention provides a server comprising a processor configured to acquire, from a terminal device, user voice information, character information, music information, and information relating to a music style; to store the user voice information and the music information as digital audio signals, and store the character information and the information relating to the music style as character strings; to generate a prompt sentence based on the character information for a generative artificial intelligence model that performs natural language processing, transmit inquiry information including the prompt sentence to the generative artificial intelligence model, acquire, from the generative artificial intelligence model, in response, shaped character information, and output the shaped character information as lyric information; to perform pitch-extraction processing on the music information to derive a pitch sequence, convert the pitch sequence into a musical symbol sequence including scale information and time information to generate melody information, determine, based on music theory and according to the information relating to the music style, a harmonic sound sequence and an accompaniment pattern, and generate an arranged audio signal based on the melody information, the harmonic sound sequence, and the accompaniment pattern; to segment unit character strings constituting the shaped character information, associate the unit character strings with the musical symbol sequence in the melody information, and generate singing control information including time information and pitch information for each of the unit character strings; to extract speaker feature information based on the user voice information, execute a voice synthesis process based on the speaker feature information and the singing control information to synthesize a singing audio signal having a voice quality of the user, and generate the singing audio signal as a vocal audio signal; to align the vocal audio signal and the arranged audio signal on a time axis, mix the vocal audio signal and the arranged audio signal, perform predetermined audio processing on a result of the mixing to generate a music audio signal, compress the music audio signal according to a predetermined encoding scheme to generate audio data for distribution or storage, and transmit the music audio signal or the audio data to the terminal device and/or an external information providing platform. This enables a unified, computer-implemented processing pipeline in which user-provided multimodal input is automatically transformed into structured lyric, melody, and accompaniment data, precisely aligned singing control information, a user-voice-based vocal track, and a mixed, encoded music audio signal, thereby improving the efficiency, automation, and personalization of music generation and delivery at the system level.

The term “user voice information” refers to digital audio data representing acoustic signals produced by a user, including but not limited to spoken utterances, sung phrases, or other vocal sounds, which are captured via an input device and stored as machine-readable audio signals.

The term “character information” refers to text data provided by a user or generated by a computing process, represented as a sequence of characters or symbols in a predefined encoding scheme, and used as a basis for natural language processing and lyric generation.

The term “music information” refers to audio data or equivalent digital representations of musical content provided by a user, including humming, sung melodies, or instrumental fragments, which can be analyzed to extract pitch, timing, and other musical features.

The term “information relating to a music style” refers to parameter data indicating a desired musical genre, mood, arrangement pattern, or stylistic attribute, which is used by a computing process to select music-theoretical rules, harmonic structures, and accompaniment patterns.

The term “digital audio signals” refers to sampled and quantized representations of sound, encoded as numerical values in a digital format, suitable for processing, storage, transmission, and playback by electronic computing equipment.

The term “character strings” refers to ordered sequences of characters encoded in a text encoding scheme, such as a series of alphanumeric symbols, punctuation, and control codes, which can be interpreted and manipulated by software components.

The term “prompt sentence” refers to a text instruction, query, or descriptive input formulated to be provided to a generative artificial intelligence model, the content of which conditions or guides the model's generation of output text.

The term “generative artificial intelligence model” refers to a computational model, typically based on machine learning such as neural networks, that generates output data including text, audio, or other content in response to input data such as a prompt sentence.

The term “inquiry information” refers to data transmitted from a computing device to a generative artificial intelligence model, including at least a prompt sentence and optionally additional parameters, which collectively define a request for generated output.

The term “shaped character information” refers to character information that has been processed by a natural language processing function or generative artificial intelligence model to satisfy grammatical, structural, or stylistic constraints, and is suitable for direct use as coherent text such as lyrics.

The term “lyric information” refers to shaped character information structured as text suitable for singing or recitation in association with a musical composition, including lines, phrases, or verses aligned with rhythmic or melodic segments.

The term “pitch-extraction processing” refers to a computational procedure that analyzes digital audio signals to estimate fundamental frequency values over time, thereby deriving a representation of perceived pitch from the audio content.

The term “pitch sequence” refers to an ordered set of pitch values or corresponding identifiers derived from audio or symbolic data, each pitch value being associated with a particular time position or duration.

The term “musical symbol sequence” refers to a series of symbolic representations of musical events, including at least pitch (or scale position) and time-related attributes such as onset and duration, which can be used to describe a melody or other musical structure.

The term “scale information” refers to data indicating pitch relationships within a musical framework, such as key, scale degrees, or note classes, which enable mapping of pitch values to a musical scale.

The term “time information” refers to data specifying temporal characteristics of musical events, including onset times, durations, tempo, and meter-related positions, used to situate musical symbols along a time axis.

The term “melody information” refers to structured data representing a sequence of musical pitches and corresponding time information, defining a melodic line suitable for playback, analysis, or further arrangement.

The term “harmonic sound sequence” refers to data specifying a series of harmonic structures, such as chords or harmonic intervals, arranged over time and intended to accompany a melody according to music-theoretical rules.

The term “accompaniment pattern” refers to data describing rhythmic, harmonic, and textural patterns used to generate instrumental or backing parts that support a melody in a musical arrangement.

The term “arranged audio signal” refers to a digital audio signal generated by applying arrangement rules, including harmonic sound sequences and accompaniment patterns, to melody information, thereby forming a structured musical backing track.

The term “unit character strings” refers to segments of character information obtained by subdividing text into smaller units, such as words, syllables, morphemes, or other linguistically meaningful segments, for use in alignment with musical elements.

The term “singing control information” refers to data specifying how textual units are to be rendered as singing, including at least time information and pitch information associated with each unit character string, and optionally phonetic or prosodic attributes.

The term “speaker feature information” refers to data representing acoustic and timbral characteristics of a particular speaker or singer, derived from analysis of user voice information and used to condition a voice synthesis model.

The term “voice synthesis process” refers to a computational procedure that generates an audio signal from symbolic or control information, such as text, phonemes, pitch curves, and speaker features, to produce speech or singing.

The term “singing audio signal” refers to a digital audio signal generated by a voice synthesis process or recorded performance, representing sung vocal content that follows specified pitch and timing patterns.

The term “vocal audio signal” refers to a singing audio signal selected or designated for use as a vocal track within a musical composition, typically to be mixed with an instrumental or arranged audio signal.

The term “music audio signal” refers to a digital audio signal representing a complete or partial musical composition, including mixed content of vocals, accompaniment, and any additional audio elements.

The term “audio data” refers to music audio signals or other digital audio content encoded according to a predefined data format or encoding scheme for storage, transmission, or distribution.

The term “encoding scheme” refers to a method or standard for converting audio signals into a compressed or formatted representation, including specific bit rates, codecs, and container formats, suitable for efficient storage or transmission.

The term “terminal device” refers to an electronic device operated by a user, such as a computing terminal, communication device, or multimedia device, capable of capturing, transmitting, receiving, and/or reproducing digital data including audio and text.

The term “external information providing platform” refers to a remote system or service accessible via a communication network, configured to store, manage, and/or distribute digital content, including audio data, to multiple users or devices.

In one embodiment, a server cooperates with a terminal and a user to implement the claimed system. The server includes at least one processor, a memory, a nonvolatile storage device such as a solid-state drive, and a network interface. The terminal includes at least one processor, a microphone, a speaker or headphone output, a user interface display, and a network interface. The user operates the terminal to provide voice, text, and music inputs and to reproduce generated musical content.

The user operates the terminal to record user voice information and music information. The terminal uses microphone hardware, for example an integrated microphone of a smartphone, and an operating system audio application programming interface such as AVFoundation on a handheld device or AudioRecord on a portable terminal, to capture acoustic signals as linear pulse-code modulation samples. The terminal encodes the samples as digital audio signals in a file format such as a WAV or FLAC file at a defined sampling rate and bit depth.

The terminal further provides a graphical user interface that the user uses to enter character information such as lyric ideas, and to select information relating to a music style such as “jazz,” “rock,” or “ballad.” The terminal represents the character information and the information relating to the music style as character strings in a text encoding such as UTF-8.

The terminal transmits the user voice information, the music information, the character information, and the information relating to the music style to the server. The terminal generates a structured payload, for example a JavaScript Object Notation structure, and sends the payload over a network using Hypertext Transfer Protocol Secure through a network interface. The server receives the payload using a web application framework, for example a Python-based framework such as FastAPI or a Java-based framework such as a general web framework, and stores binary audio data as digital audio signals in nonvolatile storage and character data as character strings in a relational database such as a general-purpose database management system.

The server uses a generative AI model to shape the character information. In one example embodiment, the server uses a large language model implementing a transformer architecture with multiple self-attention layers, feedforward layers, and layer normalization. The server stores the generative AI model locally or accesses it via an external model serving interface.

The server encodes the character information and context information such as the selected music style into a prompt sentence. The server constructs, for example, a prompt sentence such as:

“Create complete song lyrics about love and dreams. Use the following ideas: ‘love and dreams’, ‘positive’, ‘night sky’. Make the lyrics suitable for a jazz style song and keep them under 16 lines.”

The server converts the prompt sentence into subword tokens using a tokenizer such as byte-pair encoding or unigram language model tokenization. The server supplies the tokens as input to the generative AI model. The generative AI model computes hidden representations by repeatedly applying attention operations over the sequence, where for each attention head the model computes attention weights from query, key, and value vectors derived by matrix multiplication with learned weight matrices. The model then applies a decoding strategy such as top-p sampling or beam search to output a sequence of tokens that correspond to shaped character information. The server decodes the tokens into character strings, normalizes line breaks and punctuation, and stores the resulting shaped character information as lyric information.

By performing this computation inside the model and on the server, the system reduces manual text editing operations and yields lyrics that are automatically consistent with the specified style. The use of an internal tokenizer and attention mechanisms allows the server to manage long context efficiently, improving both the accuracy and consistency of the generated lyrics compared to simple rule-based text reshaping.

The server analyzes the music information to derive melody information. The server loads the digital audio signal corresponding to user-provided humming and applies a signal processing library such as librosa or a similar analysis library. The server performs short-time Fourier transform operations on overlapping frames of the audio signal to compute a time-frequency representation. The server then applies a pitch-extraction algorithm such as a YIN-based fundamental frequency estimator or a convolutional neural network-based pitch estimator. In a neural approach, the server uses a small fully convolutional network that receives log-mel spectrogram frames and outputs a probability distribution over discrete pitch bins. The server selects a pitch with maximum probability at each frame and smooths the sequence using median filtering to obtain a pitch sequence.

The server maps each element of the pitch sequence to a musical note by quantizing to the nearest semitone relative to a candidate scale. The server determines scale information and key based on pitch histogram analysis; the server computes occurrence frequencies for each pitch class and selects the scale that yields minimal deviation from the pitch sequence. The server converts the pitch sequence and frame times into a musical symbol sequence where each symbol includes at least a note name, an onset time, and a duration. The server generates melody information from the musical symbol sequence and stores the melody information in a symbolic format such as a MIDI file using a MIDI processing library.

The server determines a harmonic sound sequence and an accompaniment pattern based on the melody information and the information relating to the music style. The server uses a rule set and statistical patterns encoded in a dedicated arrangement module. For example, for a jazz style, the server applies functional harmony rules and a database of ii-V-I progressions.

The server analyzes tonic and cadence positions in the melody by examining note stability, phrase boundaries, and duration emphasis. The server selects chord roots and chord qualities according to rules that maximize stability at phrase endings and maintain stepwise bass motion where possible. The server further selects an accompaniment pattern template such as a swing comping pattern based on predefined style descriptors.

In another embodiment, the server uses a recurrent neural network or a transformer-based generative model trained on chord sequences to propose candidate chord progressions given the melody-derived features. The server encodes the melody as a sequence of pitch-class and rhythm embeddings and supplies them to the chord-generative network. The network outputs chord labels at beat-level positions, and the server postprocesses the labels to enforce stylistic constraints such as minimum chord duration and avoidance of rare chord types. The server then instantiates accompaniment instrument tracks by mapping chords and rhythmic patterns to a virtual instrument environment such as a digital audio workstation engine using sampled instruments or software synthesizers.

The server renders the arrangement as an arranged audio signal. The server loads the melody information and chord information into an audio synthesis engine, assigns instrument timbres such as plano, bass, and drums, and performs offline rendering. The server computes audio samples for each track using synthesizer algorithms, mixes the tracks with proper gain and panning, and outputs a stereo arranged audio signal stored as a high-resolution digital audio file.

The server generates singing control information by aligning the shaped character information with the melody information. The server first segments the lyric information into unit character strings, for example into syllables or phonetic units, using a language-specific tokenizer or a grapheme-to-phoneme converter. The server converts text to phoneme sequences using a pronunciation lexicon and a grapheme-to-phoneme model such as a sequence-to-sequence network trained on word-phoneme pairs. The server then divides the melody into segments corresponding to phrases or bars using the musical symbol sequence.

The server allocates unit character strings to notes by computing the number of available notes in each phrase and distributing syllables evenly while considering linguistic constraints such as avoiding breaking a word mid-syllable. The server calculates, for each syllable, a specific onset time and duration by combining note onset and duration with a small offset pattern to create natural lead-ins and holds. The server produces singing control information that includes, for each unit character string, phoneme sequence, pitch contour, and exact time indices. The server stores the singing control information in a data structure such as a structured text file or a binary message format.

The server synthesizes a singing audio signal using a voice synthesis model conditioned on speaker feature information and the singing control information. In one embodiment, the server employs a neural network-based singing voice synthesis model combining an encoder-decoder architecture with a vocoder. The server estimates speaker feature information by passing the user voice information through a speaker embedding network such as a convolutional or recurrent neural model trained to produce fixed-length vectors representing timbre. The server normalizes the embedding and caches it for subsequent synthesis.

The server uses the singing control information as input to a sequence encoder that converts phoneme embeddings, pitch values, and duration data into hidden representations. The server concatenates or otherwise conditions these hidden representations with the speaker embedding. A decoder network, for example a sequence-to-sequence model with attention, outputs an acoustic feature sequence such as mel-spectrogram frames. The server then invokes a neural vocoder such as a generative adversarial network-based or autoregressive waveform model that converts the mel-spectrogram into time-domain audio samples. The server thereby generates a singing audio signal that reflects the user's voice quality while following the melody and rhythm defined by the singing control information.

Because the server uses explicit singing control information and speaker embeddings, the synthesis module can precisely control note timing and pitch at the frame level and reduce artifacts such as timing drift and unnatural vibrato. The structured control also allows the server to adjust tempo or transpose key by deterministic transformations on the control data without retraining models, which increases computational efficiency and reduces latency.

The server generates a vocal audio signal by designating the synthesized singing audio signal as the vocal track. The server aligns the vocal audio signal with the arranged audio signal by matching time bases. If necessary, the server applies small time-stretching operations using a phase-vocoder algorithm to adjust for discrepancies in tempo or phrase length. The server mixes the signals using an audio mixing engine that performs gain adjustment, equalization, dynamic range compression, and spatialization. The server applies predetermined audio processing such as loudness normalization to a target integrated loudness level and clipping protection.

The server then encodes the resulting music audio signal according to an encoding scheme such as Advanced Audio Coding or MPEG-1 Layer III. The server selects bit rate and encoding parameters according to target distribution requirements. The server writes the compressed bitstream as audio data suitable for streaming or download. By encoding on the server, the system reduces data size compared to uncompressed audio and decreases transmission time and network usage when sending content to the terminal or to an external information providing platform.

The terminal receives the music audio signal or the audio data from the server via the network interface. The terminal stores the received file in a storage area and uses an audio playback module, such as a media playback library, to decode and play back the audio through its speaker or through connected headphones. The user listens to the generated music and may save, share, or further edit the content. In some embodiments, the server additionally transmits melody information, harmonic sound sequence, accompaniment pattern, and shaped character information in a project format compatible with a digital audio workstation. The terminal or an external production device imports this editing data to allow the user to modify arrangement parameters, lyric alignment, or mix settings.

From a technical standpoint, the described server architecture improves computer technology beyond mere automation of manual composition. The server maintains a pipeline of specialized modules-text shaping, pitch extraction, symbolic conversion, harmonization, alignment, singing control generation, voice synthesis, and audio mixing—that operate on well-defined intermediate data structures such as token sequences, pitch sequences, musical symbol sequences, phoneme sequences, and acoustic feature matrices. By structuring processing in this way, the server reduces unnecessary format conversions and minimizes repeated computation. For example, the server can reuse extracted pitch sequences for different arrangements or reuse speaker embeddings across multiple songs for the same user, which reduces computational load.

The server also improves accuracy and efficiency of alignment between lyrics and melody by computing singing control information in a deterministic and data-driven manner rather than relying solely on human timing judgment. The algorithmic matching of syllables to notes minimizes timing errors and reduces the need for manual editing, while maintaining precise, machine-usable alignment data that enables high-fidelity synthesis and easy downstream transformations.

In addition, the server uses machine-learning-based components that are trained offline using supervised learning. During training of the generative AI model and the voice synthesis model, the server or an associated training system minimizes an objective function such as cross-entropy loss for token prediction or mean squared error between predicted and ground-truth acoustic features. The training system updates network weights using a gradient-based optimization method such as stochastic gradient descent or Adam. The training system may apply data augmentation techniques such as pitch shifting, time stretching, and noise injection to improve model robustness. Although such training is typically carried out before deployment, the resulting models are specifically configured to handle multimodal inputs and generate outputs that fit into the described pipeline, thereby enhancing runtime performance on the deployed server.

Because the server performs high-dimensional vector computations, audio analysis, and generative modeling using optimized numerical libraries and hardware acceleration such as general-purpose graphics processing units, the overall system achieves generation speeds that are significantly faster than real-time playback in many cases. This enables near-real-time feedback to the user, which is difficult to achieve with manual composition and traditional, loosely integrated tools. The reduction in end-to-end latency and the efficient management of intermediate symbolic and audio data constitute improvements in the functioning of the computer system itself, not just in business convenience.

In alternative embodiments, the server may employ different network architectures for the generative AI model and the voice synthesis model, such as encoder-decoder transformers with different depth or width, or alternative vocoder architectures based on normalizing flows. The server may also vary pitch-extraction algorithms based on the expected noise conditions or vocal types. In another variant, the server may integrate the harmonic generation module and arrangement into a single generative model that directly outputs symbolic scores based on melody embeddings and style parameters. In yet another variation, the terminal may perform a subset of preprocessing operations such as initial audio encoding or on-device pitch estimation to reduce uplink bandwidth and server load, while the main shaping, arrangement, and synthesis remain on the server.

Through these embodiments, the server, terminal, and user cooperate to implement a technically specific, modular, and optimized system that performs data transformations from raw acoustic and textual inputs to finished, encoded music audio signals. The system leverages structured intermediate representations and specialized algorithms to improve computational efficiency, output quality, and control over the generated content, thereby providing concrete improvements in computer-based music generation and multimedia processing.

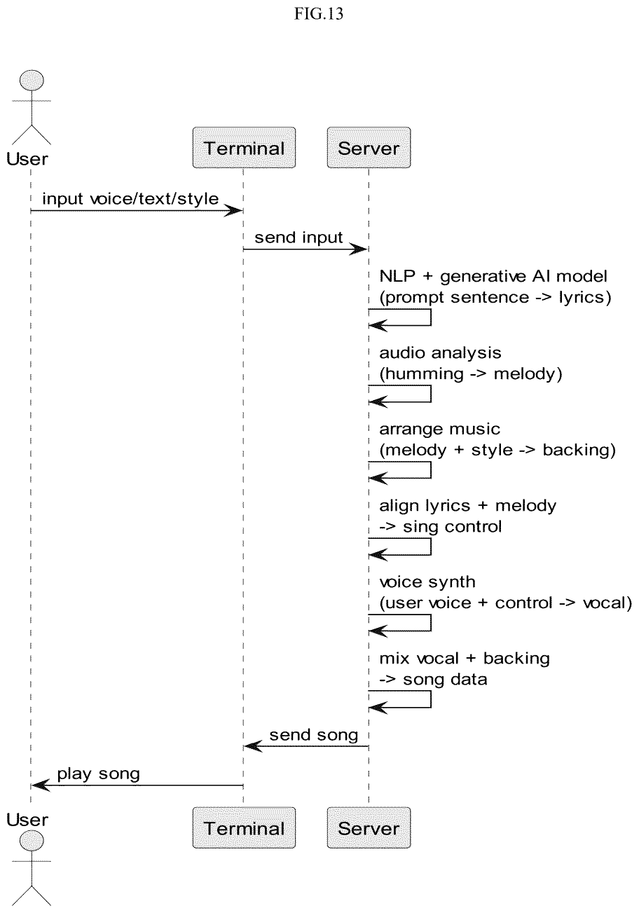

The following describes the processing flow using FIG. 13.

### Step 1:

User operates the terminal to provide input data.

User records user voice information and music information (for example, humming) using the microphone of the terminal and a recording function provided by an application. User inputs character information (for example, lyric ideas or keywords) into a text field of the application and selects information relating to a music style (for example, “jazz,” “pop,” or “rock”) using a selection interface.

Input: Human speech and humming captured by the microphone, text typed by the user, and a selected music style.

Output: Raw audio signals in analog form at the microphone, text entered in the user interface, and a style selection command.

### Step 2:

Terminal digitizes and structures the user input.

Terminal uses an operating system audio API (for example, AVFoundation or AudioRecord) to sample the analog audio, performing analog-to-digital conversion to produce linear PCM audio streams. Terminal stores these audio streams as digital audio signals in a file format (for example, WAV) with a defined sampling rate and bit depth. Terminal encodes the character information and the information relating to the music style as character strings in a text encoding, and packs these character strings together with metadata (for example, input timestamps and language settings).

Input: Analog audio from the microphone, raw text from the interface, and style selection.

Output: Digital audio files representing user voice information and music information, and character strings representing character information and information relating to a music style.

### Step 3:

Terminal prepares and transmits a request to the server.

Terminal converts the digital audio files into binary sequences and, if necessary, into Base64 -encoded strings. Terminal constructs a structured request payload (for example, a JSON object) containing fields for user voice information, music information, character information, and information relating to a music style. Terminal sends the payload via a network interface using HTTPS to a predetermined endpoint on the server.

Input: Digital audio files and character strings generated in Step 2.

Output: A network request containing the structured payload sent to the server.

### Step 4

Server receives and validates the input payload.

Server listens on an API endpoint implemented using a web framework and accepts incoming HTTPS requests. Server parses the request body to extract the fields. Server validates the payload by checking field presence, data types, and basic constraints (for example, maximum file size and allowed character encodings). If necessary, server decodes Base64 strings back into binary audio. Server writes the audio content to nonvolatile storage and inserts references to these files and the associated character strings into a database as a new job record.

Input: Structured payload transmitted from the terminal.

Output: Stored digital audio signals for user voice information and music information, stored character strings, and a job identifier recorded in the database.

### Step 5:

Server constructs a prompt sentence for a generative AI model.

Server loads the character information and the information relating to a music style from the database using the job identifier. Server generates a prompt sentence by embedding the user-provided ideas and style into a template string. Server concatenates the ideas, style descriptors, and constraints (for example, length or language) into a single text instruction.

For example, server constructs:

“Create complete song lyrics about love and dreams. Use the following ideas: ‘love and dreams’, ‘positive’, ‘night sky’. Make the lyrics suitable for a jazz style song and keep them under 16 lines.”

Input: Character information (user lyric ideas) and information relating to a music style loaded from the database.

Output: A constructed prompt sentence text string.

### Step 6:

Server generates shaped character information using a generative AI model.

Server sends the prompt sentence to a generative AI model that implements a transformer-based language architecture. Server tokenizes the prompt sentence into discrete tokens and passes the token sequence to the model. The model performs attention-based computations over the token sequence, propagating activations through multiple layers to predict a probability distribution over possible next tokens. Server applies a decoding strategy (for example, top-p sampling) to iteratively select output tokens until a stopping condition is met.

Server then detokenizes the output token sequence into text, performs normalization (for example, trimming whitespace and standardizing line breaks), and designates the result as shaped character information. Server stores the shaped character information in the database as lyric information.

Input: Prompt sentence from Step 5.

Output: Shaped character information (lyric information) stored as a text string in the database.

### Step 7:

Server extracts a pitch sequence from the music information.

Server loads the digital audio file representing the user's humming from storage. Server applies a signal processing function to compute a time-frequency representation, such as a short-time Fourier transform or log-mel spectrogram. Server then applies a pitch-extraction algorithm (for example, a YIN-based estimator or a small convolutional neural network) to each analysis frame. The algorithm outputs, for each frame, an estimated fundamental frequency. Server aggregates these frame-level estimates into a time-ordered pitch sequence and removes unvoiced or low-confidence frames based on thresholding.

Input: Digital audio signal representing music information.

Output: A pitch sequence consisting of estimated fundamental frequencies with associated time indices.

### Step 8:

Server converts the pitch sequence into melody information.

Server maps each frequency value in the pitch sequence to the nearest musical note using a logarithmic frequency-to-semitone conversion. Server groups consecutive frames with similar pitches into note events, calculating onset time and duration for each event. Server analyzes the distribution of pitch classes to infer scale and key, and associates each note with scale information. Server creates a musical symbol sequence including, for each note, a pitch designation, onset time, and duration. Server stores this sequence as melody information, for example in a MIDI-like internal structure.

Input: Pitch sequence with time indices from Step 7.

Output: Melody information represented as a musical symbol sequence.

### Step 9:

Server generates a harmonic sound sequence and an accompaniment pattern.

Server analyzes the melody information to identify phrase boundaries and structural accents (for example, long notes and notes near bar lines). Server applies style-specific harmony rules or a trained chord generation model to select chords for each segment. Server determines chord roots and qualities so that downbeats align with harmonically stable chords and cadences occur at phrase endings. Server chooses an accompaniment pattern template corresponding to the selected music style, such as a swing comping rhythm or a straight eighth-note pattern. Server encodes the harmonic sound sequence and accompaniment pattern as structured data (for example, chord labels with durations and rhythmic pattern descriptors).

Input: Melody information and information relating to a music style.

Output: Harmonic sound sequence and accompaniment pattern data structures.

### Step 10:

Server synthesizes an arranged audio signal.

Server loads the melody information, harmonic sound sequence, and accompaniment pattern into an audio synthesis module. Server assigns virtual instruments (for example, a plano, bass, and percussion) to the different parts. Server converts symbolic note events into audio by driving software synthesizers or sample players, computing audio samples for each instrument track according to pitch, timing, and dynamics information. Server mixes these tracks to form a stereo arranged audio signal and writes it as a high-resolution audio file.

Input: Melody information, harmonic sound sequence, and accompaniment pattern.

Output: Arranged audio signal representing an instrumental backing track.

### Step 11:

Server generates singing control information by aligning lyrics with melody.

Server retrieves shaped character information (lyric information) and melody information from the database. Server segments the shaped character information into unit character strings (for example, syllables) using a tokenizer and converts each unit into a phoneme sequence with a grapheme-to-phoneme converter. Server divides the melody into segments corresponding to phrases and computes the number of notes in each phrase. Server distributes unit character strings over the notes such that each syllable is mapped to at least one note, adjusting for natural word boundaries. For each unit character string, server calculates an onset time and duration based on the onset and duration of the associated note or group of notes, and associates the corresponding pitch values. Server aggregates this information into singing control information that includes time information, pitch information, and phoneme data for each unit character string.

Input: Shaped character information and melody information.

Output: Singing control information that aligns text units with musical notes.

### Step 12:

Server extracts speaker feature information from user voice information.

Server reads the digital audio file representing user voice information (for example, recorded spoken sentences). Server passes the audio through a feature extraction module that computes frame-level acoustic features such as mel-spectrograms. Server feeds these features into a speaker embedding network trained to output a fixed-dimensional vector that captures timbral characteristics of the speaker. Server averages or otherwise aggregates frame-level embeddings to obtain a single speaker feature vector representing the user. Server stores this speaker feature information for use in synthesis.

Input: Digital audio signal representing user voice information.

Output: Speaker feature information in the form of an embedding vector.

### Step 13:

Server synthesizes a singing audio signal using a voice synthesis process.

Server loads the singing control information and the speaker feature information. Server encodes the phoneme sequences, pitch contours, and durations from the singing control information into numerical feature sequences. Server concatenates or conditions these features with the speaker feature vector and inputs them to a sequence-to-sequence acoustic model (for example, an encoder-decoder neural network). The acoustic model outputs a sequence of acoustic features such as mel-spectrogram frames corresponding to the desired singing. Server then supplies these acoustic features to a vocoder model that converts them into time-domain audio samples. Server concatenates the generated samples over time to form a singing audio signal that reflects both the control information and the user's voice quality.

Input: Singing control information and speaker feature information.

Output: Singing audio signal representing the synthesized vocal performance.

### Step 14:

Server generates a vocal audio signal and performs time alignment.

Server designates the singing audio signal as the vocal audio signal and loads the arranged audio signal from storage. Server compares the duration and tempo of the vocal audio signal and the arranged audio signal using time markers or beat positions. If necessary, server adjusts small timing discrepancies by applying time-stretching or compression to one of the signals using a phase-coherent time-scaling algorithm. Server ensures that phrase boundaries and note onsets in the vocal audio signal align with corresponding positions in the arranged audio signal.

Input: Singing audio signal and arranged audio signal.

Output: Time-aligned vocal audio signal and arranged audio signal.

### Step 15:

Server mixes the vocal audio signal with the arranged audio signal to create a music audio signal.

Server inputs both the aligned vocal audio signal and the arranged audio signal into an audio mixing engine. Server sets volume levels, equalizer parameters, and dynamic range compression settings for each track to achieve a balanced mix. Server may apply reverb or other effects to the vocal track to integrate it spatially with the accompaniment. Server sums the processed tracks to produce a stereo mix, monitors peak and average levels, and applies loudness normalization and limiting to meet target levels. Server outputs the result as a music audio signal in an uncompressed format.

Input: Aligned vocal audio signal and arranged audio signal.

Output: Mixed music audio signal representing the complete song.

### Step 16:

Server compresses the music audio signal into audio data suitable for distribution or storage.

Server selects an encoding scheme (for example, a perceptual audio codec) and configuration parameters such as bit rate and channel mode. Server passes the music audio signal through an encoder implementation that transforms the signal into a compressed bitstream. Server writes the bitstream into a file container and generates metadata such as title, artist name placeholder, and style tags. Server stores the compressed file as audio data in nonvolatile storage and updates the job record with a reference to the file.

Input: Music audio signal in uncompressed form.

Output: Compressed audio data ready for transmission or storage.

### Step 17:

Server delivers results to the terminal and optionally to an external platform.

Server responds to a status query from the terminal by indicating completion and providing a download location for the audio data. Server transmits the audio data to the terminal over HTTPS, and may also transmit melody information, harmonic sound sequence, accompaniment pattern, and shaped character information as editing data. Optionally, server transmits the audio data to an external information providing platform and registers it for streaming or download.

Input: Music audio data and associated metadata retrieved from storage.

Output: Audio data and optional editing data sent to the terminal, and optionally registered content on an external platform.

### Step 18:

Terminal receives and plays back the generated content for the user.

Terminal downloads the audio data from the server using the provided location and stores it in local storage. Terminal uses an audio playback module to decode the compressed audio into PCM samples and sends the samples to the audio output hardware such as a built-in speaker or connected headphones. User listens to the generated music and may interact with playback controls provided by the terminal, such as play, pause, seek, or save.

Input: Audio data and optional editing data received from the server.

Output: Audible playback of the generated music to the user and stored content on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented music generation systems suffer from several technical limitations in how they process multimodal user inputs and how they generate and distribute customized musical content. First, known systems typically treat user voice signals, text data, and melody inputs as independent streams and do not perform integrated extraction of melody structure information, syntactic information, and emotion information in a unified processing pipeline. As a result, processing units cannot consistently align pitch, timing, and linguistic structure, which leads to inaccurate melody extraction, unstable timing, and poor synchronization between lyrics and melody on the machine side.

Second, conventional generative systems often pass raw or weakly structured inputs directly to a generative AI model without constructing a context-rich prompt sentence that encodes melody structure, music attributes, and emotion with sufficient precision. This causes the generative AI model to operate with ambiguous conditioning, increasing computational overhead due to repeated trial generation and manual post-editing, and degrading reproducibility of results in a computer environment.

Third, existing arrangement engines generally apply music theory rules to a melody in isolation and do not tightly couple generated harmony information, accompaniment information, and composition information with both emotion analysis results and user-specific voice characteristics. In such systems, the processor cannot effectively optimize key, tempo, and instrumentation for a given user voice profile, which leads to technically suboptimal signal ranges, artifacts during subsequent voice synthesis, and additional processing for correction.

Fourth, typical voice synthesis pipelines in music applications do not derive a persistent voice characteristic profile from user voice information and then reuse this profile as a conditioning signal for synthesizing singing voices strictly aligned to generated lyrics data and melody data. Instead, they rely on generic timbres or ad hoc parameter settings, which reduces the precision of mapping between user-specific acoustic features and synthesized waveforms, and increases the computational cost of repeated reconfiguration for each song.

Fifth, conventional systems often generate audio content without generating tightly synchronized notation information and associated image information from the same symbolic representation. As a consequence, additional conversion steps are required, which may introduce timing inconsistencies between rendered scores and audio, thereby increasing processing latency and complexity.

Sixth, known distribution workflows typically perform file export and manual upload to external distribution platforms. Processors in such systems do not automatically convert internally represented music content data and notation data into standardized digital distribution formats and do not autonomously manage network transfer to distribution information processing apparatuses. This results in redundant I/O operations, increased user interaction steps, and inefficient use of network and storage resources.

Seventh, existing systems do not provide the generated music content data as structured editable music information including multitrack audio information and control information in a form that is natively consumable by external editing processing apparatuses. This restricts downstream editing to destructive waveform manipulation, limits automation of parameter changes, and forces users to rely on manual import/export operations, which is inefficient from a computer systems perspective.

Accordingly, there is a need for a computer-implemented system and server-side processing architecture that: (i) integrates voice, text, melody, and music attribute inputs into a coherent internal representation; (ii) constructs and applies a structured prompt sentence to a generative AI model for deterministic and efficient generation of lyrics data and melody data; (iii) algorithmically determines harmony, accompaniment, and composition based on music theory and emotion information; (iv) derives and uses user-specific voice characteristic information to synthesize singing voices aligned with generated content; (v) generates notation information and corresponding image information from the same symbolic data used for audio; and (vi) automatically prepares and delivers both playback-ready and editing-ready data formats and digital distribution formats over a network, thereby improving the efficiency, reliability, and technical quality of computer-based music generation and distribution.

The specific processing by the specific processing unit 290 of the data processing device 12 in Application Example 2 is realized by the following means.

The present invention provides a server comprising a processor configured to receive, as input, user voice information, character information, melody information, and music attribute information; to execute digital signal processing on the user voice information and the melody information to extract melody structure information including pitch information and time information; to execute statistical language processing and natural language processing on the character information to obtain syntactic information and emotion information and to generate character information shaped for lyrics based on the syntactic information and the emotion information; to algorithmically construct a prompt sentence based on the melody structure information, the character information shaped for lyrics, the music attribute information, and the emotion information; to supply the prompt sentence to a generative artificial intelligence model as conditioning information and to cause the generative artificial intelligence model to generate music generation data including lyrics data and melody data; to determine harmony information, accompaniment information, and composition information by applying music-theory-based rules and models to the music generation data; to generate arranged music data by combining the melody data with the harmony information and the accompaniment information; to extract voice characteristic information from the user voice information and to generate synthesized voice data based on the voice characteristic information, the lyrics data, and the melody data; to generate music content data by combining the synthesized voice data with the arranged music data; to generate notation information corresponding to the music content data and to render the notation information as image information; and to store and provide the music content data and the image information in data formats retrievable by a terminal device and convertible into digital distribution formats and editable music information including multitrack audio information and control information. This enables integrated and automated computer-side processing that (i) aligns multimodal user inputs into a unified internal representation, (ii) drives a generative AI model through structured prompt sentences for reproducible and resource-efficient generation of lyrics and melody, (iii) produces user-personalized, emotion-aware arrangements and synthesized singing voices using voice characteristic information, (iv) derives synchronized audio, notation, and visual outputs from common symbolic music generation data, and (v) prepares and distributes playback-ready and editing-ready content over a network with reduced manual intervention and improved computational efficiency in a music generation and distribution environment.

The term “user voice information” refers to audio data that represents vocal sounds produced by a user, including spoken voice, sung voice, and humming, captured by an input transducer and stored in a digital format suitable for signal processing.

The term “character information” refers to text data composed of characters, symbols, or strings input by a user, including lyrics, free-form messages, or descriptive phrases, which can be processed by natural language processing techniques.

The term “melody information” refers to data representing a sequence of musical tones or pitches over time, including humming, whistling, or instrument-played sequences, expressed as audio or symbolic data and usable for melody extraction and generation.

The term “music attribute information” refers to control parameters that specify desired characteristics of music, including but not limited to genre, style, tempo range, mood, and instrumentation preferences.

The term “melody structure information” refers to symbolic information describing a melody in terms of musical attributes, including pitch information, time information, note durations, and timing positions within measures.

The term “pitch information” refers to data elements that represent the perceived frequency of sounds, including note identifiers, pitch classes, and octaves, suitable for mapping to a musical scale.

The term “time information” refers to data elements that represent temporal aspects of musical events, including onset times, offsets, durations, beat positions, and measure indices.

The term “syntactic information” refers to structural information derived from character information by natural language processing, including sentence boundaries, parts of speech, phrase structure, and grammatical relationships.

The term “emotion information” refers to data indicating an emotional state or sentiment associated with character information or user inputs, including categories such as joy, sadness, anger, fear, calmness, or composite emotional values with intensities.

The term “natural language processing technology” refers to computational techniques and algorithms that analyze and transform human language text, including tokenization, parsing, semantic analysis, sentiment analysis, and text generation.

The term “character information shaped for lyrics” refers to character information that has been transformed or reformatted so that it is suitable for use as song lyrics, including alignment to rhythmic structures, line breaks, verse-chorus structures, and adjusted vocabulary.

The term “prompt sentence” refers to a structured text instruction or query supplied to a generative AI model to condition or guide the model's output generation, including embedded contextual information such as melody structure, music attributes, and emotion information.

The term “generative AI model” refers to a computational model, typically realized by a machine learning or neural network architecture, configured to generate new data samples such as text, music, or audio based on input conditions including prompt sentences and control parameters.

The term “music generation data” refers to intermediate symbolic data produced by a generative AI model for constructing music content, including lyrics data, melody data, and optional control metadata used for subsequent arrangement or synthesis.

The term “lyrics data” refers to textual sequences generated or selected for use as sung words in a musical composition, which can be aligned with musical notes on a time axis.

The term “melody data” refers to symbolic representations of a melodic line, including sequences of notes with associated pitch information and time information, suitable for arrangement, synthesis, and notation.

The term “music theory” refers to formalized rules, models, and structures that describe properties and organization of music, including scales, keys, chords, harmonic progressions, rhythm, meter, and form.

The term “harmony information” refers to data describing chord structures, harmonic progressions, and vertical pitch relationships that accompany or support a melody in a musical composition.

The term “accompaniment information” refers to data describing additional musical parts, such as bass lines, chord voicings, rhythmic patterns, and instrumental arrangements, that are combined with a melody to form a complete musical backing.

The term “composition information” refers to data describing the overall structural organization of a musical work, including sections such as intro, verse, chorus, bridge, and outro, and their ordering and lengths.

The term “arranged music data” refers to music data in which melody data has been combined with harmony information and accompaniment information according to music theory and composition information to form a structured arrangement.

The term “voice characteristic information” refers to data describing acoustic and prosodic features of a user's voice, including pitch range, timbre-related spectral features, formants, speaking or singing style, vibrato characteristics, and timing tendencies, derived through audio analysis.

The term “synthesized voice data” refers to audio data generated by a voice synthesis process, in which textual and musical inputs are converted into artificial yet human-like vocal waveforms, optionally conditioned on voice characteristic information.

The term “music content data” refers to audio data representing a complete musical piece, including at least a vocal component and an instrumental arrangement, optionally accompanied by associated metadata.

The term “notation information” refers to structured symbolic data representing musical content in a format suitable for music notation, including pitch, duration, meter, key, lyrics alignment, and other score-related attributes.

The term “image information” refers to digital image data that visually represents notation information, including staff notation, lyrics, and symbols, in formats such as raster images or vector graphics.

The term “terminal device” refers to an information processing apparatus operated by a user, including but not limited to a smartphone, tablet, personal computer, or other client device, configured to send inputs to and receive outputs from a server over a communication network.

The term “digital distribution format” refers to a standardized data format for distributing media content over a network, including audio file formats, container formats, and associated metadata structures compatible with distribution platforms.

The term “distribution information processing apparatus” refers to a remote computing system operated by a distribution service provider that receives digital distribution format data and makes the corresponding content available to client devices over a network.

The term “editable music information” refers to data representing music content in a structured form that can be manipulated by an editing processing apparatus, including separate tracks, events, and control parameters accessible for modification.

The term “multitrack audio information” refers to audio data separated into multiple individual tracks or channels, each corresponding to a distinct source or instrument, enabling independent editing, mixing, or processing of each track.

The term “control information” refers to non-audio data used to affect the behavior of music playback or processing, including volume envelopes, automation curves, tempo maps, effect parameters, and track configuration data.

The term “editing processing apparatus” refers to an information processing system, such as a digital audio workstation or music production device, configured to receive editable music information and to modify, mix, or re-render the music content.

In one embodiment, a server, a plurality of terminal devices, and a communication network cooperate to implement the claimed system. The server comprises at least one processor, a main memory storing executable programs and data structures, a nonvolatile storage device, and a network interface. The terminal comprises a processor, a memory, a display, a user input interface (for example, a touch panel and a keyboard), an audio input transducer (for example, a microphone), an audio output transducer (for example, a loudspeaker or headphones), and a communication interface.

The server executes a set of software modules including: an audio preprocessing module, a melody extraction module, a natural language processing module, an emotion analysis module, a prompt construction module, a generative AI module interface, a music arrangement module, a voice analysis module, a singing-voice synthesis module, a notation generation module, and a distribution/format-conversion module. Each module operates on specific data structures and transforms them into other structures in a manner configured to improve computational efficiency, accuracy of audio-text alignment, and quality of synthesized musical outputs.

The terminal behaves as a client device that acquires user inputs and displays or reproduces server outputs. The terminal executes client software that records user voice information as digital audio, acquires character information from user input operations, and optionally acquires melody information by recording humming or by receiving note events from a musical input device. The terminal constructs a request payload including the user voice information, the character information, the melody information, and music attribute information such as genre, mood, and tempo preference, and transmits the payload to the server over the network.

The server, upon receiving the payload, stores the raw user voice information and melody information in a compressed or uncompressed waveform format in main memory and/or secondary storage. The server uses an audio preprocessing module implemented with a digital signal processing library (for example, a library of short-time Fourier transform and filterbank operations analogous to those found in general audio analysis toolkits) to convert the waveform data into a time-frequency representation. This module splits the waveform into overlapping frames, computes spectral features including magnitude spectrograms and mel-frequency cepstral coefficients, and normalizes amplitudes.

The server uses the melody extraction module to compute melody structure information. The melody extraction module comprises a pitch estimator that applies a time-domain or frequency-domain pitch detection algorithm, such as an autocorrelation-based method or a neural pitch estimator, to each frame. The module then aggregates frame-level fundamental frequency estimates into note candidates by segmenting the time axis based on pitch continuity and amplitude thresholds. The module quantizes continuous pitch values into discrete musical notes using a scale- and key-estimation algorithm, and assigns durations by measuring time intervals between onsets and offsets of note segments. The melody extraction module outputs melody structure information as a data structure including, for each note, a pitch identifier, a start time, an end time, and an optional bar and beat index. The server stores this structure as melody data in memory.

The server uses the natural language processing module to process character information. The module tokenizes the input text, assigns part-of-speech tags by using a statistical or neural tagger, and constructs a syntactic parse tree. The module computes syntactic information such as sentence boundaries, noun and verb phrases, and dependency relations. The server then uses this syntactic information to shape the character information into character information shaped for lyrics. The shaping process divides the text into lyric lines and sections (for example, verse and chorus) by applying rules that consider phrase boundaries and target syllable counts per musical bar. The module, for example, may merge short sentences to form a lyric line or split long sentences at conjunctions. The server stores the shaped character information as structured lyric lines aligned with an approximate metrical grid.

The server uses the emotion analysis module to derive emotion information from the character information and, optionally, from prosodic characteristics in the user voice information. The module applies a classifier implemented by a neural network having, for example, a bidirectional recurrent layer (such as a long short-term memory layer) or a transformer-based encoder, which receives token embeddings of the character information as input and outputs emotion category scores. The module calculates, for each emotion category (such as joy, sadness, anger, calmness), a probability value, and selects the category with the highest score as the primary emotion. The module also computes an intensity scalar based on the classifier's confidence score. The server stores the emotion information as a record including the emotion category and intensity.

The server then uses the prompt construction module to generate a prompt sentence to be supplied to a generative AI model. The module collects melody structure information, character information shaped for lyrics, music attribute information, and emotion information. The module arranges these elements into a natural language text string following a pre-defined template that exposes relevant technical constraints to the generative AI model.

For example, the server may construct a prompt sentence as:

“Using the following user melody and emotion, generate complete song lyrics and a melody description.
Genre: pop
Emotion: happiness (intensity 0.8)
Base text from user: ‘Today I feel very happy’
Melody notes (MIDI, time): [C4 quarter, D4 quarter, E4 quarter, G4 half]
Return: 1) final lyrics with line breaks and syllable counts per bar; 2) a detailed melody line aligned to bars and beats.”

The server supplies the prompt sentence to the generative AI model via the generative AI module interface. In one embodiment, the generative AI model is implemented as a transformer-based sequence-to-sequence neural network trained on large corpora of lyrics and symbolic music. The model receives tokenized prompt text as input. The server uses an embedding layer to convert tokens into continuous vectors, applies multiple self-attention and feed-forward layers to compute contextualized representations, and decodes outputs sequentially using an autoregressive mechanism with beam search. During training, the model may be optimized by minimizing a cross-entropy loss function between predicted tokens and reference tokens, with parameters updated by a gradient-based algorithm such as stochastic gradient descent or an adaptive method. Data augmentation during training may include random transposition of melodies, random phonetic perturbation of lyrics, or masking of emotion terms.

The generative AI model outputs music generation data, including lyrics data and melody data, encoded as token sequences. The server decodes these sequences into a structured format: for lyrics, a list of lines and syllables; for melody, a list of notes with pitch and duration relative to bars. The server merges this music generation data with the previously extracted melody structure information, where appropriate, to ensure continuity between user-provided melodic content and generated content.

The server uses the music arrangement module to compute harmony information, accompaniment information, and composition information. The module may employ a neural network trained on symbolic music sequences or a rule-based engine that applies chord-progression patterns according to the emotion information and music attribute information.

For example, when emotion information indicates sadness and the music attribute information indicates a ballad style, the module selects minor-key scales, slower tempos, and sparse instrumentation. The arrangement module analyses the melody data to detect key, phrase boundaries, and cadential points, and assigns chord labels that satisfy voice-leading constraints. The module generates accompaniment patterns, such as arpeggios or rhythmic chord patterns, by using a generative model conditioned on chord progression and meter. The module outputs arranged music data as a multi-track symbolic representation including a melody track, one or more harmony and accompaniment tracks, and structural markers for sections such as intro, verse, chorus, and bridge.

The server uses the voice analysis module to derive voice characteristic information from the user voice information. This module analyzes the waveform using spectral analysis and pitch tracking to compute features such as average pitch, pitch range, spectral envelope, formant locations, harmonic-to-noise ratio, and vibrato characteristics. The module may also apply a speaker-embedding network to map the voice into a compact vector representation. The server stores the voice characteristic information as a feature vector and statistical descriptors.

The server uses the singing-voice synthesis module to generate synthesized voice data based on the voice characteristic information, the lyrics data, and the melody data. The module may be implemented as a neural singing-voice synthesizer with an encoder-decoder architecture.

A text encoder converts phoneme sequences derived from lyrics data into embeddings; a melody encoder converts note sequences into pitch and duration embeddings; a speaker encoder incorporates voice characteristic information. A decoder generates an acoustic representation such as a mel-spectrogram by conditioning on all three encodings, and a neural vocoder converts the spectrogram into a time-domain waveform. During training of this model, the system can minimize a loss function combining reconstruction error of acoustic features and adversarial loss terms, with parameters updated by backpropagation. The use of explicit voice characteristic information ensures that the synthesized voice waveform closely matches the timbral qualities of the user voice, thereby improving the naturalness and personalization of the output.

The server combines the synthesized voice data with the arranged music data. If the arranged music data is stored in symbolic form, the server first renders it to an audio waveform by using a software synthesizer or sample-based playback engine. The server then performs time alignment between the vocal waveform and the instrumental waveform, for example by matching beat positions and bar indices. The server mixes the signals using digital mixing operations, including gain adjustment, stereo panning, and insertion of audio effects such as reverberation and equalization. The server thus generates music content data as a final audio file that embeds both vocals and instruments.

The server uses the notation generation module to create notation information corresponding to the music content data. The module converts the symbolic representation of melody data and accompaniment tracks into a music notation format by assigning notes to staves, determining clefs, key signatures, and time signatures, and aligning lyrics under the appropriate notes. The module may apply rules for layout and spacing to maximize readability. The module then renders the notation information as image information, such as raster images or vector graphic documents, by using a score-rendering engine. The server stores the image information alongside the music content data.

The server uses the distribution/format-conversion module to prepare the music content data and image information for retrieval and distribution. The module converts internal audio representations into standardized audio formats (for example, compressed formats) and embeds metadata including artist name, title, and genre. The module converts notation data into standard document formats such as image files or page description languages. The module stores such data in a database or file system accessible via the network interface. The server can also convert the music content data and notation information into digital distribution formats and transmit them to a distribution information processing apparatus operated by a content delivery provider.

The server, in some embodiments, also generates editable music information including multitrack audio information and control information. The arrangement module and mixing module, instead of reducing all tracks to a single mixed waveform, can store individual tracks (for example, lead vocal, backing vocals, drums, bass, and each melodic instrument) as separate files or channels, together with automation curves for volume, panning, and effects.

The server encodes this information into a structured project file format used by external editing processing apparatuses or exports separate track files with accompanying control information. This arrangement reduces the computational burden on external devices because the server already organizes data into a form that maps directly to track structures and control lanes used in digital audio workstations.

The server, by tightly controlling the above-described data structures and algorithmic pipelines, achieves technical effects that go beyond manual human workflows and beyond conventional automated systems. The integrated use of melody structure information, syntactic information, and emotion information in the prompt sentence for the generative AI model constrains the model's search space and prevents unnecessary generations that would otherwise require repetition and manual correction. This reduces computational load on the processor and accelerates response time. The explicit alignment of lyric syllables with note events and beats enables the singing-voice synthesis module to produce timing-accurate waveforms without applying extensive time-stretching or alignment corrections, thereby reducing numerical errors and artifacts.

The neural architectures used in the emotion analysis module, generative AI model, and singing-voice synthesis module use specific structures and loss functions that achieve improved performance for this domain. For example, the emotion classifier may employ a transformer encoder trained with a cross-entropy loss over emotion labels and a regularization term that penalizes inconsistent predictions between similar phrases. The generative AI model may use multi-head attention layers that explicitly attend to token spans representing melody structure and emotion tags, which ensures that output lyrics match the meter and emotional content encoded in the prompt sentence. The singing-voice synthesis network may use a multi-task loss that combines reconstruction of spectral features with pitch accuracy penalties to stabilize pitch generation.

The server, in some configurations, uses rule-based post-processing on the generative AI model outputs. For instance, when the generated melody data conflicts with the user's original melody structure information, the server may apply a non-conventional rule that enforces user melody segments at selected bar positions while permitting the generative AI model to fill only unoccupied sections. This rule-based partial overwriting ensures that user intent is respected while leveraging generative capabilities only where needed, thereby reducing re-synthesis and improving data reuse.

The system, by organizing all intermediate results as explicit data structures (for example, arrays of notes with bar indices, parse trees for lyrics, and feature vectors for voice characteristics), allows the processor to perform deterministic computations and optimizations that are not feasible in purely manual workflows. The server, by automatically converting music content data and notation information into distribution formats and editable project formats, reduces the number of conversions and file operations required at client-side devices, which in turn reduces network traffic and memory consumption on terminals.

The terminal, in this embodiment, simply receives completed music content data and image information from the server and presents them to the user. The terminal plays back the audio, displays the notation images on the screen, and optionally allows the user to trigger a share operation, which causes the terminal to send a command to the server to initiate distribution.

The terminal itself does not perform heavy computational tasks; instead, the server centralizes and optimizes processing, which allows for better control of computational resources and algorithmic improvements.

In another embodiment, the server may implement alternative neural network architectures for some modules. For emotion analysis, the server may use a convolutional neural network that receives character-level embeddings of the text and outputs emotion information. For music arrangement, the server may employ a graph neural network that models relationships between chords and melody notes. For singing-voice synthesis, the server may use a sequence of a duration predictor and a non-autoregressive decoder to increase synthesis speed. The system can also support alternative input sources: the melody information may be provided as MIDI data directly from an electronic instrument connected to the terminal instead of as raw audio. The processing pipeline remains similar because the melody extraction module receives symbolic notes and bypasses pitch estimation.

The system described above thus implements the claimed processor configuration in a concrete infrastructure that uses specific hardware components and software modules. The server performs structured data transformations, uses defined neural network architectures and rule-based algorithms, and coordinates storage and network transmission. This configuration yields tangible technical effects such as reduced processing latency for music generation, improved alignment accuracy between lyrics and melody, improved naturalness of synthesized singing through voice characteristic modeling, and reduced communication overhead by producing distribution-ready and editing-ready formats on the server side before network transmission.

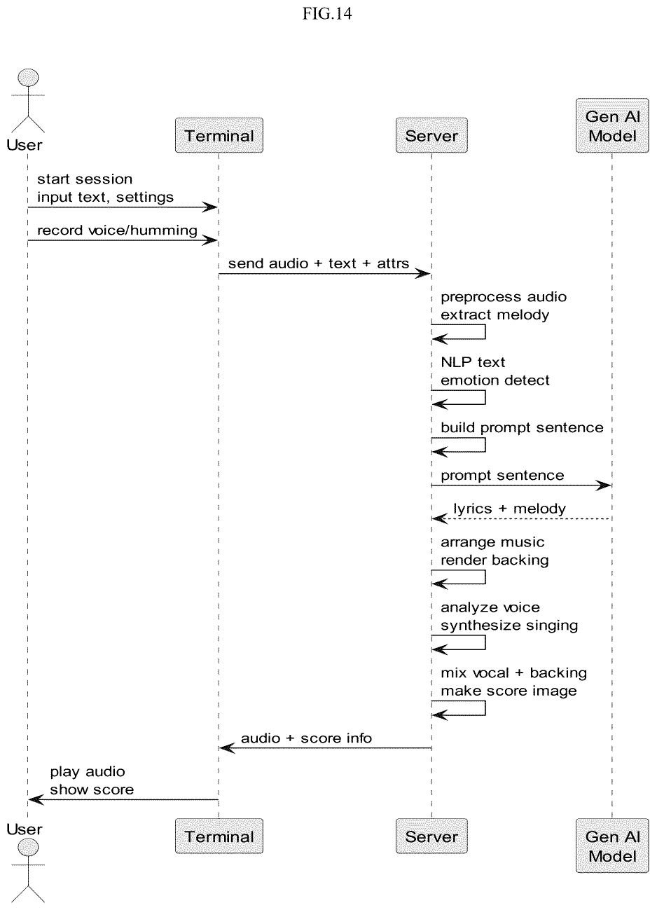

The following describes the processing flow using FIG. 14.

### Step 1:

User operates the terminal to start a music creation session.

User speaks, sings, or hums into the microphone of the terminal and also inputs character information via a keyboard or touch interface.

Terminal records the user voice information and melody information as digital audio signals (for example, PCM waveform at a fixed sampling rate) and stores the data temporarily in memory.

Terminal receives character information (for example, “Today I feel very happy. I want an upbeat pop song.”) and music attribute information (for example, genre=pop, mood=happy, tempo preference=fast) from the user interface.

Terminal constructs a request including the user voice information, the melody information, the character information, and the music attribute information, and transmits the request to the server via a network protocol.

Input: raw acoustic signal from the microphone and text input from the user.

Output: a structured request message containing digital audio data, text data, and control parameters sent to the server.

### Step 2:

Server receives the request message from the terminal through a network interface and stores the user voice information and melody information in a buffer.

Server applies an audio preprocessing routine to the waveform, dividing it into overlapping frames and computing features such as magnitude spectra and mel-frequency cepstral coefficients.

Server uses these features to normalize the amplitude and filter background noise, thereby generating a cleaned waveform suitable for further analysis.

Input: raw waveform data from the terminal.

Output: normalized and noise-reduced waveform data and frame-level spectral features stored in server memory.

### Step 3:

Server executes a melody extraction process on the preprocessed audio.

Server applies a pitch detection algorithm to each frame, estimating a fundamental frequency value for the frame or marking it as unvoiced.

Server aggregates frame-level pitch estimates into continuous segments, each segment representing a candidate note, and determines onset and offset times for the segments.

Server quantizes each segment's average pitch to a discrete musical note (for example, MIDI number) and computes note durations from the onset and offset times.

Server assigns bar and beat indices to each note by using an estimated tempo and meter, thereby creating melody structure information.

Input: normalized waveform data and spectral features.

Output: melody structure information including a list of notes with pitch identifiers, start times, end times, and bar/beat positions.

### Step 4:

Server processes the character information using natural language processing.

Server tokenizes the character information into words and punctuation, assigns part-of-speech tags, and constructs a syntactic dependency tree.

Server analyzes the tree to identify sentence boundaries, phrase structures, and clause relationships.

Server uses this syntactic information to shape the character information into lyric-suitable text by inserting line breaks at phrase boundaries, distributing syllables across lines, and grouping lines into sections such as verse and chorus.

Input: raw character information from the user.

Output: character information shaped for lyrics, represented as structured lyric lines and sections with associated syntactic annotations.

### Step 5:

Server executes emotion analysis on the character information and optionally on prosodic cues from the user voice information.

Server encodes the character information into token embeddings, feeds them into an emotion classifier model (for example, a neural network with attention layers), and obtains a probability distribution over predefined emotion categories.

Server selects the highest-probability category as the primary emotion and computes an intensity value from the confidence score or softmax output.

Server stores emotion information as a record that includes the emotion category (for example, happiness) and an intensity value (for example, 0.8).

Input: character information and optionally acoustic features of the user voice.

Output: emotion information describing the detected emotion category and intensity.

### Step 6:

Server constructs a prompt sentence for a generative AI model.

Server gathers melody structure information, character information shaped for lyrics, music attribute information, and emotion information into a single context.

Server inserts these elements into a template to form a natural language text instruction, ensuring that bar structure, genre, emotion, and base text are explicitly specified.

Server generates a text string such as:

“Using the following user melody and emotion, generate complete song lyrics and a melody description.
Genre: pop
Emotion: happiness (intensity 0.8)
Base text from user: ‘Today I feel very happy. I want an upbeat pop song.’
Melody notes (MIDI, time): [C4 quarter, D4 quarter, E4 quarter, G4 half]
Return: 1) final lyrics with line breaks and syllable counts per bar; 2) a detailed melody line aligned to bars and beats.”

Input: melody structure information, character information shaped for lyrics, music attribute information, and emotion information.

Output: a structured prompt sentence ready to be supplied to the generative AI model.

### Step 7:

Server calls the generative AI model interface and supplies the prompt sentence as input.

Server encodes the prompt sentence into tokens, forwards them through a transformer-based generative AI model configured to output sequences representing lyrics data and melody data.

Server receives from the model a token sequence that corresponds to refined lyrics and a corresponding melody description, and decodes this sequence into structured data forms.

Server maps the decoded tokens into lyric lines, syllables, and corresponding note events, and verifies consistency between lyrical meter and bar structure.

Input: prompt sentence describing context, melody, and desired output format.

Output: music generation data including lyrics data and melody data generated by the generative AI model.

### Step 8:

Server combines the music generation data with previously extracted melody structure information when necessary.

Server identifies sections where the user's original melody should be preserved and sections where generated melody can be inserted or modified.

Server merges notes from user-provided melody and generated melody based on bar indices and structural markers, thereby constructing a unified melody data structure.

Input: melody structure information from the user and melody data from the generative AI model.

Output: unified melody data that respects user-provided content and incorporates generated segments.

### Step 9:

Server performs music arrangement using music theory and generative algorithms.

Server analyzes the unified melody data to estimate key, mode, and phrase boundaries, and then selects chord progressions that satisfy harmonic rules and reflect the emotion information and music attribute information.

Server generates harmony information as a sequence of chords aligned with bars and sections.

Server generates accompaniment information (for example, bass lines, rhythmic patterns, and arpeggios) by applying pre-learned accompaniment patterns or a generative sequence model conditioned on chords, meter, and emotion.

Server defines composition information that specifies the order and length of sections (intro, verse, chorus, bridge, outro) and maps melody and accompaniment segments to these sections.

Input: unified melody data, music attribute information, and emotion information.

Output: arranged music data including melody, harmony information, accompaniment information, and composition information.

### Step 10:

Server converts arranged music data into a symbolic multi-track format and, when needed, renders it to an audio waveform.

Server assigns each musical role (melody, chords, bass, drums, and other instruments) to a separate symbolic track representing note-on and note-off events with associated velocities and channels.

Server feeds the symbolic tracks into a software synthesizer or sound library to generate audio waveforms for each track, and stores each instrument's waveform as an individual audio stream.

Input: arranged music data in symbolic form.

Output: multitrack symbolic representation and corresponding multitrack audio waveforms.

### Step 11:

Server analyzes user voice information to obtain voice characteristic information.

Server extracts pitch statistics, spectral envelopes, formant locations, and temporal features from the user's voice waveform using signal processing operations and possibly a speaker-embedding network.

Server compiles these features into a voice characteristic vector or profile that parameterizes timbre, pitch range, and style.

Input: user voice information from the terminal.

Output: voice characteristic information describing user-specific vocal traits.

### Step 12:

Server synthesizes a singing voice based on the lyrics data, unified melody data, and voice characteristic information.

Server converts lyrics data into phoneme sequences and aligns them with notes in the unified melody data by mapping syllables to note events.

Server feeds phoneme sequences, note sequences, and the voice characteristic vector into a singing-voice synthesis network that predicts an acoustic representation such as a mel-spectrogram.

Server passes the predicted spectrogram through a neural vocoder to generate a time-domain synthesized voice waveform that imitates the user's voice.

Input: lyrics data, unified melody data, and voice characteristic information.

Output: synthesized voice data representing the user's voice singing the generated song.

### Step 13:

Server mixes the synthesized voice data with the multitrack audio waveforms of the arranged music.

Server aligns the timing of the vocal waveform and instrumental waveforms using bar and beat information, and adjusts delays so that lyrics coincide with the intended musical positions.

Server applies gain control, panning, equalization, and reverberation to blend the vocal and instrumental tracks, and sums the tracks into a stereo or multi-channel master mix.

Input: synthesized voice data and multitrack instrumental audio.

Output: music content data as a mixed audio file that includes both vocals and accompaniment.

### Step 14:

Server generates notation information corresponding to the arranged music and lyrics.

Server converts melody, harmony, and accompaniment events into score elements by placing notes on staves, assigning clefs, meter, key signatures, and adding chord symbols.

Server aligns lyrics under the corresponding melody notes based on syllable-to-note mapping.

Server formats the score layout and exports it as notation information in an internal format.

Input: arranged music data and lyrics data.

Output: notation information representing the musical score with aligned lyrics.

### Step 15:

Server renders the notation information as image information suitable for display and printing.

Server calls a score-rendering engine to draw staff lines, noteheads, rests, accidentals, beams, ties, chords, dynamics, and lyrics text into one or more pages.

Server outputs the rendered score as image files or document files and stores them in association with the music content data.

Input: notation information.

Output: image information representing the score in visual form.

### Step 16:

Server prepares distribution-ready and editing-ready formats for the generated content.

Server encodes the music content data into standard audio formats and attaches metadata such as title, artist, and genre.

Server packages the notation image information into standard document formats and optionally bundles it with the audio file.

Server also constructs editable music information by preserving or exporting multitrack audio information and control information (for example, automation curves) in a project or interchange format.

Input: music content data, multitrack audio waveforms, control information, and image information.

Output: distribution-ready audio files, notation images, and editable music information in structured formats.

### Step 17:

Server stores the distribution-ready and editing-ready data in a storage subsystem and registers their locations in a database indexed by user and project identifiers.

Server responds to the terminal with URLs or identifiers that allow the terminal to retrieve the mixed audio, score images, and optional project files.

Server, if instructed by the user, transmits the distribution-ready audio and associated metadata to a distribution information processing apparatus over the network to enable public or private streaming.

Input: generated file objects and metadata.

Output: stored and retrievable content records and, optionally, uploaded assets on external distribution platforms.

### Step 18:

Terminal receives the server response and updates the user interface to present playback and viewing options.

Terminal requests the audio file and score images using the provided URLs or identifiers and streams or downloads them.

Terminal plays the music content data through its audio output device and displays the notation image information on its display, allowing the user to listen to and visually inspect the generated song.

Input: response message from the server containing references to content.

Output: rendered audio and visual presentation of the generated music to the user.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

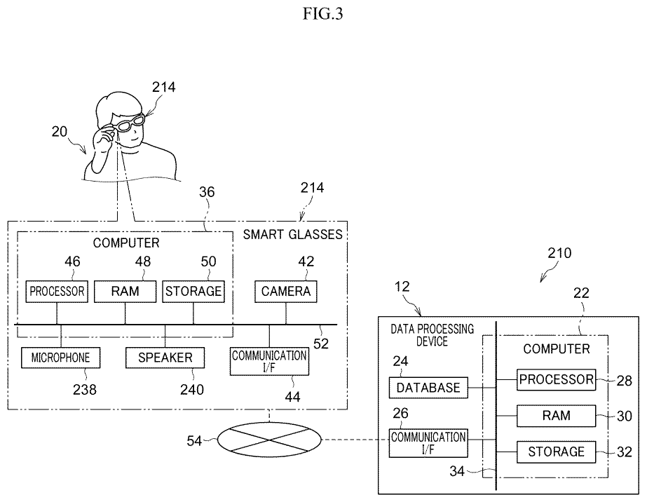

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

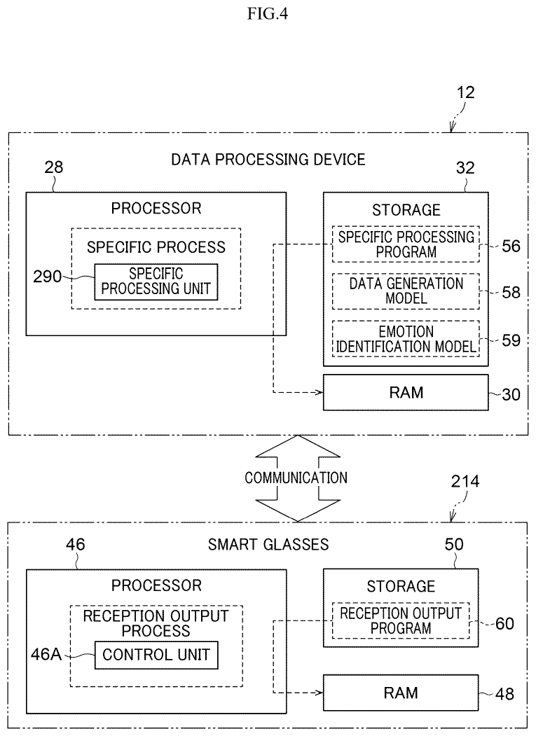

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

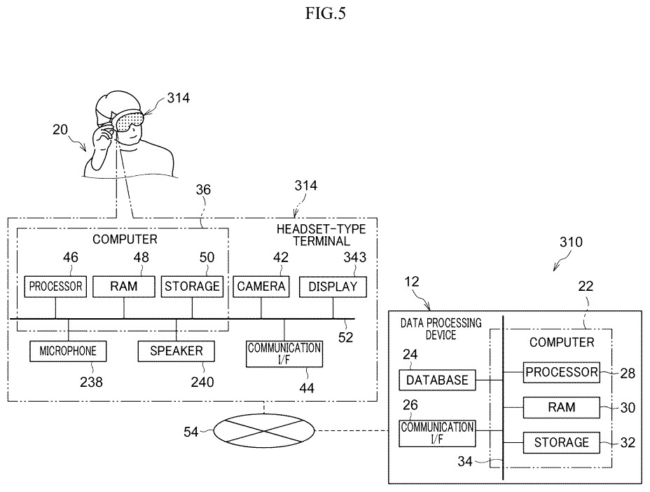

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

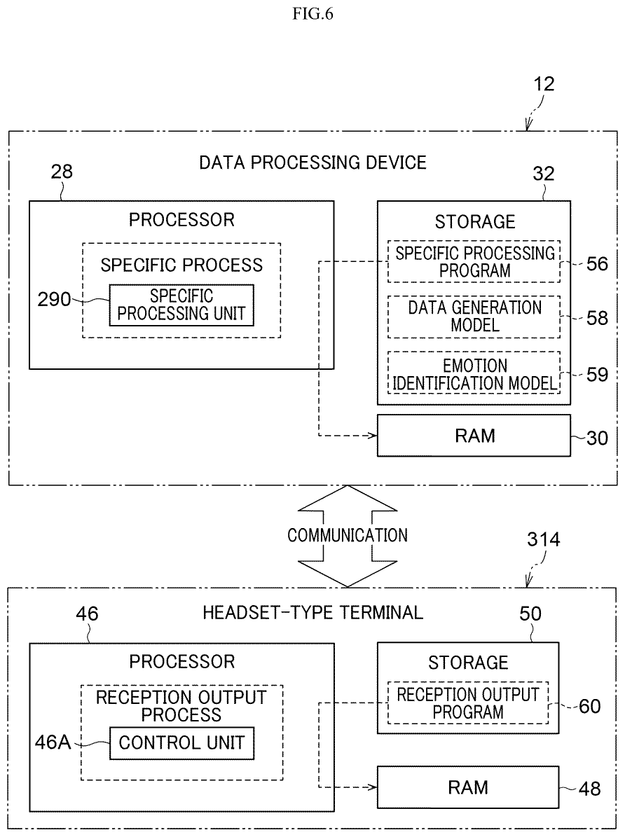

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

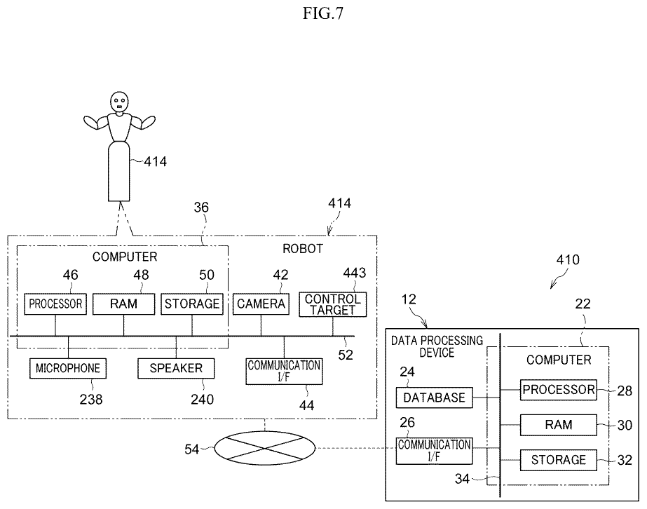

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

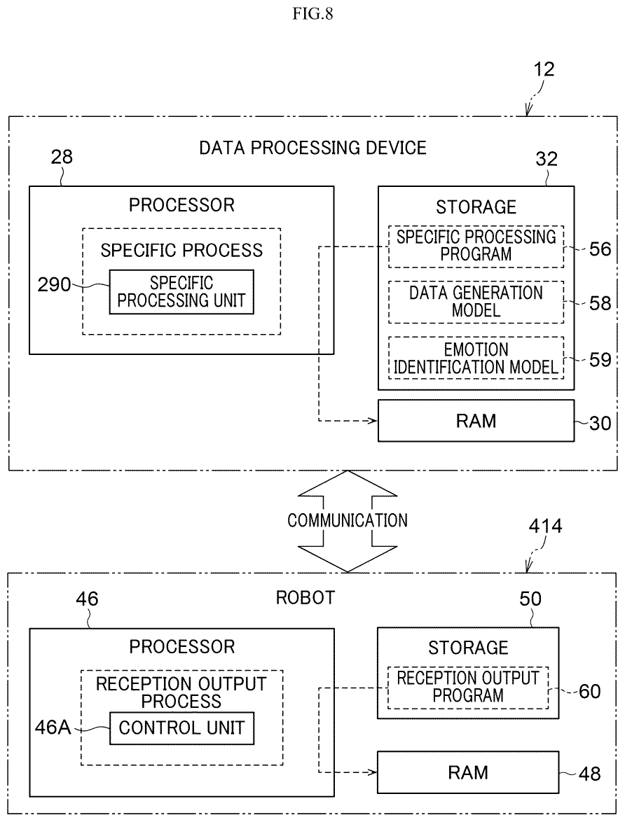

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

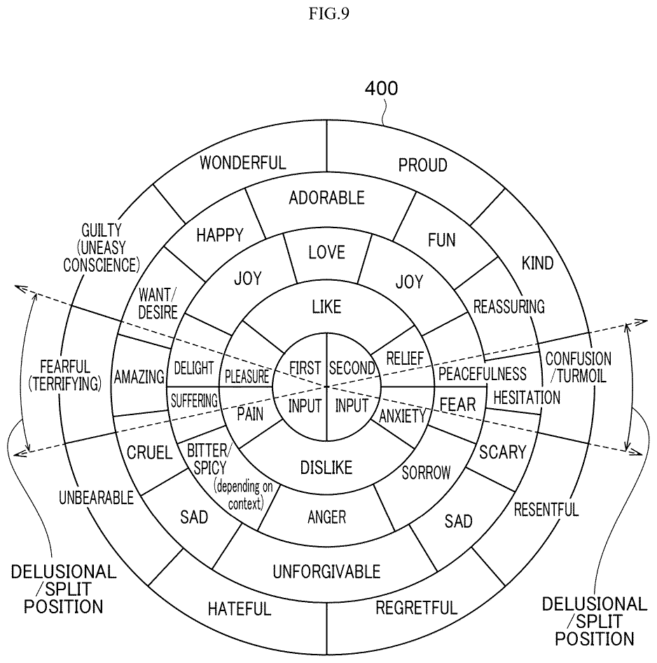

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

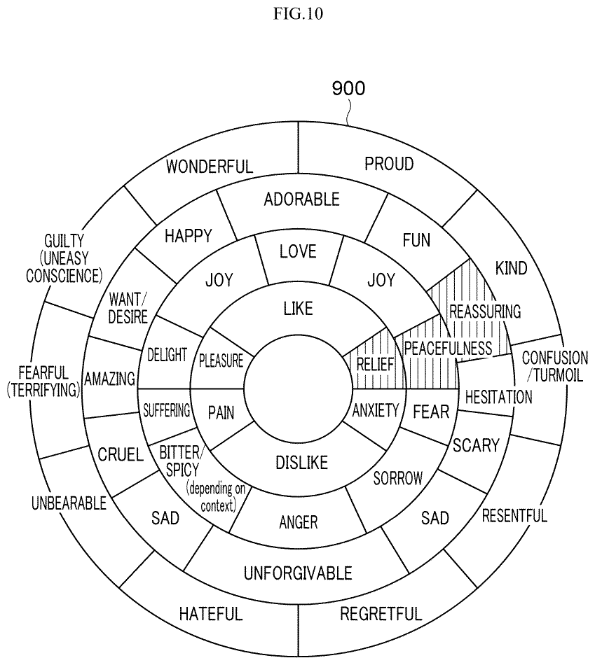

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, as inputs, user voice information, character information, melody information represented by voice, and music type information, convert the user voice information and the melody information represented by voice into character information by using a speech recognition technique, and generate basic data in which the converted character information is integrated with the character information,
generate model input information by constructing, on the basis of the basic data and the music type information, a prompt sentence in a natural language including emotion information and structure information, the prompt sentence being configured for input to a generative artificial intelligence model,
obtain music information including musical structure information and performance information from the generative artificial intelligence model by using the model input information, and output the music information as symbolic information or waveform information,
when the music information is the symbolic information, convert the symbolic information into an acoustic waveform by a synthesis process and encode the acoustic waveform as a digital music file in a standardized acoustic data format,
store the digital music file in a storage device, associate the digital music file with identification information and attribute information for management, and generate distribution information that enables an external terminal to access the digital music file, and accumulate, as record information, correspondence among the basic data, the prompt sentence, identification information of the generative artificial intelligence model, and the digital music file, and manage a generation history of music on the basis of the record information.

### (Supplementary 2)

The system according to supplementary 1, wherein the processor is configured to use the distribution information to transmit the digital music file to an external apparatus via a communication path and to control so that a user is able to reproduce or acquire the digital music file at the external apparatus.

### (Supplementary 3)

The system according to supplementary 1,
wherein the processor is configured to provide, to an external apparatus, the music information corresponding to the digital music file in an editable information format and to control so that a user is able to modify the music information at the external apparatus and acquire a regenerated digital music file.

### Application Example 1

### (Supplementary 1)

A system comprising a processor,
wherein the processor is configured to
acquire, as input information, user voice information, character string information, melody information, and music type information, analyze the user voice information and the melody information in a time domain or a frequency domain by executing a signal processing program to extract melody feature information and rhythm feature information, and analyze the character string information by executing a natural language processing program to perform syntactic analysis and semantic analysis so as to generate shaped character string information suitable for a musical structure, and
construct, in a natural language, a prompt sentence for input to a generative artificial intelligence model on the basis of the extracted melody feature information and the rhythm feature information, the shaped character string information, and the music type information, and supply the prompt sentence to the generative artificial intelligence model to obtain music design information including musical structure information, chord progression information, and arrangement instruction information, and
generate musical description information including pitch information and time information on the basis of the obtained music design information, execute a music encoding program that generates control information sequences using the musical description information to generate musical control data, and generate arranged acoustic data by controlling an acoustic synthesis program or an acoustic synthesis apparatus on the basis of the musical control data, and
generate singing voice data by executing a speech synthesis program that uses the shaped character string information and the musical description information and uses the user voice information as speaker feature information, and perform mixing processing of the singing voice data and the arranged acoustic data to generate user voice reproduction acoustic data, and
output the arranged acoustic data and the user voice reproduction acoustic data as music production data in an editable format associated with editing information including time position information, section structure information, and volume information, and enable the music production data to be updated in response to editing instructions from a terminal apparatus, and
store the music production data or final acoustic data generated on the basis of the music production data in an external storage apparatus, and output, as distribution data, the final acoustic data stored in the external storage apparatus so as to be transmittable to a distribution management information processing apparatus via a communication network.

### (Supplementary 2)

The system according to supplementary 1,
wherein the processor is configured to
execute an editing processing program using the editing information acquired from the terminal apparatus to perform section deletion, section extension, volume adjustment, or structure change on the musical description information and the musical control data, and regenerate the arranged acoustic data or the user voice reproduction acoustic data on the basis of edited musical control data so as to generate music production data reflecting an editing result.

### (Supplementary 3)

The system according to supplementary 1,
wherein the processor is configured to
construct a new prompt sentence on the basis of additional expression instruction information acquired from the terminal apparatus and the music design information, re-input the new prompt sentence to the generative artificial intelligence model to regenerate music design information corresponding to a partial section of a musical piece, and update a part of the musical control data and the arranged acoustic data on the basis of the regenerated music design information.

### Example 2

### (Supplementary 1)

A system comprising a processor,
wherein the processor is configured to
acquire, from a terminal device, user voice information, character information, music information, and information relating to a music style, store the user voice information and the music information as digital audio signals, and store the character information and the information relating to the music style as character strings,
generate a prompt sentence based on the character information for a generative artificial intelligence model that performs natural language processing, transmit inquiry information including the prompt sentence to the generative artificial intelligence model, acquire, from the generative artificial intelligence model, in response, shaped character information, and output the shaped character information as lyric information,
perform pitch-extraction processing on the music information to derive a pitch sequence, convert the pitch sequence into a musical symbol sequence including scale information and time information to generate melody information, determine, based on music theory and according to the information relating to the music style, a harmonic sound sequence and an accompaniment pattern, and generate an arranged audio signal based on the melody information, the harmonic sound sequence, and the accompaniment pattern,
segment unit character strings constituting the shaped character information, associate the unit character strings with the musical symbol sequence in the melody information, and generate singing control information including time information and pitch information for each of the unit character strings,
extract speaker feature information based on the user voice information, execute a voice synthesis process based on the speaker feature information and the singing control information to synthesize a singing audio signal having a voice quality of the user, and generate the singing audio signal as a vocal audio signal,
align the vocal audio signal and the arranged audio signal on a time axis, mix the vocal audio signal and the arranged audio signal, perform predetermined audio processing on a result of the mixing to generate a music audio signal, and compress the music audio signal according to a predetermined encoding scheme to generate audio data for distribution or storage, and transmit the music audio signal or the audio data to the terminal device to enable reproduction by the user.

### (Supplementary 2)

The system according to supplementary 1,
wherein the processor is configured to
transmit the music audio signal or the audio data to an external information providing platform, register the music audio signal or the audio data in the external information providing platform for distribution, and thereby make the music audio signal or the audio data available via a network.

### (Supplementary 3)

The system according to supplementary 1,
wherein the processor is configured to
provide the melody information, the harmonic sound sequence, the accompaniment pattern, and the shaped character information, as editing data, to the terminal device or an external device in an information format or project format for music editing, and thereby enable reception of operations from the user for changing audio signals or music structure.

### Application Example 2

### (Supplementary 1)

A system comprising a processor,
wherein the processor is configured to
receive, as input, user voice information, character information, melody information, and music attribute information, and extract melody structure information including pitch information and time information based on the user voice information and the melody information,
analyze the character information by using natural language processing technology to obtain syntactic information and emotion information, and generate character information shaped for lyrics based on the syntactic information and the emotion information,
generate a prompt sentence to be input to a generative AI model based on the melody structure information, the character information shaped for lyrics, the music attribute information, and the emotion information, and cause the generative AI model to generate music generation data including lyrics data and melody data,
determine harmony information, accompaniment information, and composition information based on the music generation data and music theory, and generate arranged music data by combining the melody data with the harmony information and the accompaniment information,
analyze voice characteristic information based on the user voice information, generate synthesized voice data based on the voice characteristic information, the lyrics data, and the melody data, and generate music content data by combining the synthesized voice data with the arranged music data,
generate notation information corresponding to the music content data and output the notation information as image information, and
store and provide the music content data and the image information in a format retrievable by a terminal device.

### (Supplementary 2)

The system according to supplementary 1,
wherein the processor is configured to convert the music content data and the image information into a digital distribution format, transmit data in the digital distribution format to a distribution information processing apparatus, and thereby enable the music content data to be distributed via a network.

### (Supplementary 3)

The system according to supplementary 1,
wherein the processor is configured to output the music content data as editable music information including multitrack audio information and control information, and provide the editable music information in a format modifiable by an external editing processing apparatus or a terminal device.

What is claimed is:

1. A system comprising:
circuitry configured to:
receive, via a communication interface coupled to a packet-switched network, user voice information, character information, melody information represented by voice, and music type information from a terminal device;
convert the user voice information and the melody information represented by voice into character information using a speech recognition component, and generate basic data by integrating the converted character information with the received character information;
construct, based on the basic data and the music type information, a prompt sentence in a natural language including emotion information and structure information, and transmit model input information including the prompt sentence to a generative neural network model;
obtain, from the generative neural network model, music information including musical structure information and performance information, and output the music information as symbolic information or waveform information;
when the music information is the symbolic information, convert the symbolic information into an acoustic waveform by a synthesis process and encode the acoustic waveform as a digital music file in a standardized acoustic data format; and
store the digital music file in a storage device associated with identification information and attribute information to generate distribution information enabling an external terminal to access the digital music file, and accumulate record information representing a correspondence among the basic data, the prompt sentence, identification information of the generative neural network model, and the digital music file.

2. The system according to claim 1, wherein the circuitry is configured to analyze the user voice information and the melody information in a time domain or a frequency domain by executing a signal processing program to extract melody feature information and rhythm feature information, and incorporate the melody feature information and the rhythm feature information into the prompt sentence.

3. The system according to claim 2, wherein the circuitry is configured to analyze the character information by executing a natural language processing program to perform syntactic analysis and semantic analysis, and generate shaped character information representing character strings formatted into a musical structure suitable for lyric generation.

4. The system according to claim 3, wherein the circuitry is configured to obtain, from the generative neural network model, music design information including chord progression information and arrangement instruction information, generate musical description information including pitch information and time information based on the music design information, and execute a music encoding program to generate control information sequences from the musical description information.

5. The system according to claim 4, wherein the circuitry is configured to segment unit character strings constituting the shaped character information, associate the unit character strings with a musical symbol sequence in the musical description information, and generate singing control information including time information and pitch information for each of the unit character strings.

6. The system according to claim 5, wherein the circuitry is configured to extract speaker feature information from the user voice information, execute a voice synthesis process based on the speaker feature information and the singing control information to synthesize a singing audio signal having a voice quality of the user, and generate the singing audio signal as a vocal audio signal.

7. The system according to claim 6, wherein the circuitry is configured to mix the vocal audio signal with an accompaniment audio signal generated from the arrangement instruction information and the chord progression information to produce a mixed audio signal, and encode the mixed audio signal as the digital music file.

8. The system according to claim 7, wherein the circuitry is configured to determine, based on music theory and according to the music type information, a harmonic sound sequence and an accompaniment pattern, and generate an arranged audio signal based on the musical symbol sequence, the harmonic sound sequence, and the accompaniment pattern.

9. The system according to claim 1, wherein the circuitry is configured to perform pitch-extraction processing on the melody information to derive a pitch sequence, convert the pitch sequence into a musical symbol sequence including scale information and time information, and use the musical symbol sequence in constructing the prompt sentence.

10. The system according to claim 9, wherein the circuitry is configured to transmit inquiry information including the prompt sentence to the generative neural network model, acquire shaped character information from the generative neural network model in response to the inquiry information, and output the shaped character information as lyric information for the digital music file.

11. The system according to claim 1, wherein the circuitry is configured to generate the distribution information by associating the digital music file with a file identifier, a creation timestamp, and metadata attributes derived from the music type information and the basic data, and store the distribution information in a manner enabling retrieval by an external digital distribution service.

12. The system according to claim 11, wherein the circuitry is configured to transmit the distribution information to a digital distribution service via the communication interface to cause the digital music file to be published on a digital distribution platform.

13. The system according to claim 1, wherein the circuitry is configured to provide the digital music file in an editable format including at least one of a symbolic music notation format and a multitrack audio format to enable music production editing by a user.

14. The system according to claim 13, wherein the circuitry is configured to transmit the editable format digital music file to the terminal device via the communication interface, and store a correspondence between the editable format file and the distributed format file in the storage device indexed by a session identifier.

15. The system according to claim 1, wherein the circuitry is configured to perform sentiment analysis on the basic data to generate sentiment information, and incorporate the sentiment information into the prompt sentence to instruct the generative neural network model to adjust an emotional characteristic of the music information based on the sentiment information.

16. The system according to claim 15, wherein the circuitry is configured to update the prompt sentence by replacing the emotion information component with updated sentiment information derived from additional user input received from the terminal device, and transmit the updated prompt sentence to the generative neural network model to regenerate the music information.

17. The system according to claim 1, wherein the circuitry is configured to accumulate the record information including the correspondence among the basic data, the prompt sentence, the identification information of the generative neural network model, and the digital music file in the storage device, and use the accumulated record information to manage a generation history and enable regeneration of prior digital music files.

18. A system comprising:
circuitry configured to:
receive, via a communication interface coupled to a packet-switched network, user voice information, character information, melody information represented by voice, and music type information from a terminal device;
convert the user voice information and the melody information into character information using a speech recognition component and generate basic data by integrating the converted character information with the received character information;
analyze the user voice information and the melody information in a time domain or a frequency domain to extract melody feature information and rhythm feature information, analyze the character information using a natural language processing program to generate shaped character information, and construct a prompt sentence including the melody feature information, the rhythm feature information, the shaped character information, and the music type information;
transmit the prompt sentence to a generative neural network model and obtain music design information including musical structure information, chord progression information, and arrangement instruction information;
generate musical description information including pitch information and time information from the music design information, execute a music encoding program to generate control information sequences, and convert the control information sequences into an acoustic waveform by a synthesis process;
extract speaker feature information from the user voice information, execute a voice synthesis process based on the speaker feature information to synthesize a vocal audio signal, mix the vocal audio signal with an accompaniment audio signal to produce a digital music file; and
store the digital music file with identification information and distribution information in a storage device, and transmit distribution information enabling access to the digital music file to the terminal device via the communication interface.

19. The system according to claim 18, wherein the circuitry is configured to provide the digital music file in an editable format including at least one of a symbolic music notation format and a multitrack audio format, and accumulate record information representing a correspondence among the basic data, the prompt sentence, the identification information of the generative neural network model, and the digital music file.

20. A method comprising:
receiving, via a communication interface coupled to a packet-switched network, user voice information, character information, melody information represented by voice, and music type information from a terminal device;
converting the user voice information and the melody information represented by voice into character information using a speech recognition component, and generating basic data by integrating the converted character information with the received character information;
constructing, based on the basic data and the music type information, a prompt sentence in a natural language including emotion information and structure information, and transmitting model input information including the prompt sentence to a generative neural network model;
obtaining, from the generative neural network model, music information including musical structure information and performance information, and outputting the music information as symbolic information or waveform information;
when the music information is the symbolic information, converting the symbolic information into an acoustic waveform by a synthesis process and encoding the acoustic waveform as a digital music file in a standardized acoustic data format; and
storing the digital music file in a storage device associated with identification information and attribute information to generate distribution information enabling an external terminal to access the digital music file, and accumulating record information representing a correspondence among the basic data, the prompt sentence, identification information of the generative neural network model, and the digital music file.
